(19) United States
(12) Patent Application Publication
(10) Pub. No.: US 2014/0223359 A1
(43) Pub. Date: Aug. 7, 2014

(54) DISPLAY PROCESSOR AND DISPLAY PROCESSING METHOD

(71) Applicant: Kabushiki Kaisha Toshiba, Tokyo (JP)

(72) Inventor: Masahiro YAMADA, Tokyo (JP)

(73) Assignee: Kabushiki Kaisha Toshiba, Tokyo (JP)

(21) Appl. No.: 14/194,145

(22) Filed: Feb. 28, 2014

Related U.S. Application Data
(63) Continuation of application No. PCT/JP2013/058738, filed on Mar. 26, 2013.

(30) Foreign Application Priority Data
Feb. 5, 2013 (JP) 2013020911

(51) Int. Cl. G06F 3/0484; G06F 3/0488

(52) U.S. Cl. CPC G06F 3/04845; G06F 3/0488
USPC 715/798

(57) ABSTRACT

According to one embodiment, display processor includes display, detector, communication module, and display controller. The display controller displays first animation upon receipt of data from the communication terminal when contact of the communication terminal within a display area is detected by the detector, or displays second animation upon transmission of data to the communication terminal when contact of the communication terminal within the display area is detected by the detector. The first animation moves display information representing the data received by the communication module so that a size of the display information is increased from a position at which the contact of the communication terminal is detected. The second animation moves display information representing the data transmitted to the communication module so that a size of the display information is decreased toward a position at which the contact of the communication terminal is detected.

### CROSS-REFERENCE TO RELATED APPLICATIONS

This application is a continuation of international application No. PCT/JP2013/058738, filed Mar. 26, 2013, which designates the United States, incorporated herein by reference, and which is based upon and claims the benefit of priority from Japanese Patent Application No. 2013-020911, filed Feb. 5, 2013, the entire contents of which are incorporated herein by reference.

### FIELD

Embodiments described herein relate generally to a display processor and a display processing method.

### BACKGROUND

Conventional, there has been known a display processor comprising a user interface using a touch panel. The display processor can transmit and receive data to and from other communication terminals by receiving operations via the user interface.

However, according to the conventional technique, it is difficult to visually recognize a communication status between a mobile terminal and the display processor.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary hardware configuration diagram of a display processor according to an embodiment;

FIG. 2 is an exemplary diagram illustrating a modification in which a projector is used to perform displaying on a wall face, in the embodiment;

FIG. 3 is an exemplary diagram illustrating a data structure of an icon data table stored in an icon storage module in the embodiment;

FIG. 4 is an exemplary diagram of a hardware configuration of a mobile terminal in the embodiment;

FIG. 5 is an exemplary diagram illustrating an example of a user interface screen of when a terminal cooperation program is executed in the display processor, in the embodiment;

FIG. 6 is an exemplary diagram illustrating a timing chart of when cooperative processing is executed between the display processor and the mobile terminals, in the embodiment;

FIG. 7 is an exemplary diagram illustrating a timing chart of when the cooperative processing is executed between the display processor and the mobile terminals, in the embodiment;

FIG. 8 is an exemplary diagram illustrating an example of screen transitions by display control of a display controller, in the embodiment;

FIG. 9 is an exemplary diagram illustrating an example of screen transitions by display control of the display controller according to a modification of the embodiment;

FIG. 10 is an exemplary diagram illustrating an example of destinations of icons moved by the display controller in the embodiment;

FIG. 11 is an exemplary diagram illustrating an example of an area that starts an upload according to a modification of the embodiment;

FIG. 12 is an exemplary diagram illustrating placement of the mobile terminal when data is to be downloaded from the display processor in the embodiment;

FIG. 13 is an exemplary diagram illustrating an example of screen transitions performed in display control by the display controller in the embodiment;

FIG. 14 is an exemplary diagram illustrating a reduction movement of an icon by the display controller when the mobile terminal is placed at the upper left of the icon, in the embodiment;

FIG. 15 is an exemplary diagram illustrating a reduction movement of an icon by the display controller when the mobile terminal is placed at the upper right of the icon, in the embodiment;

FIG. 16 is an exemplary diagram illustrating a reduction movement of an icon by the display controller when the mobile terminal is placed near the center of the icon, in the embodiment;

FIG. 17 is an exemplary diagram illustrating a modification in which a download button for downloading data represented by an icon is displayed, in the embodiment;

FIG. 18 is an exemplary diagram illustrating an example of screen transitions by display control of the display controller according to a modification of the embodiment;

FIG. 19 is an exemplary diagram illustrating an example of screen transitions by display control of the display controller according to a modification of the embodiment;

FIG. 20 is an exemplary diagram illustrating an example of screen transitions by display control of the display controller according to a modification of the embodiment;

FIG. 21 is an exemplary diagram illustrating a display mode of the display processor and the mobile terminal during a download, in the embodiment;

FIG. 22 is an exemplary flowchart illustrating a process until communication with the mobile terminal starts in the display processor in the embodiment;

FIG. 23 is an exemplary flowchart illustrating a process until a program is stated to start communication in the display processor in the embodiment;

FIG. 24 is an exemplary flowchart illustrating a process in the display processor in the embodiment when a touched icon is associated with a video, in the embodiment;

FIG. 25 is an exemplary flowchart illustrating a process in the display processor when the touched icon is associated with music, in the embodiment;

FIG. 26 is an exemplary flowchart illustrating a process in the display processor when the touched icon is associated with a photograph, in the embodiment;

FIG. 27 is an exemplary flowchart illustrating a process in which the display processor downloads the video data to the mobile terminal, in the embodiment;

FIG. 28 is an exemplary flowchart illustrating a process in the display processor when the touched icon is associated with an upload, in the embodiment; and

FIG. 29 is an exemplary flowchart illustrating a process in the display processor when an upload of video data from the mobile terminal is accepted, in the embodiment.

### DETAILED DESCRIPTION

In general, according to one embodiment, a display processor comprises a display, a detector, a communication module, and a display controller. The display comprises a display area. The detector is configured to detect contact within the display area. The communication module is configured to allow transmission and reception of data with respect to a communication terminal. The display controller is configured to display animation upon receipt of data from the communication terminal by the communication module when contact of the communication terminal within the display area is detected by the detector, or to display animation upon transmission of data to the communication terminal by the communication module when contact of the communication terminal within the display area is detected by the detector. The animation displayed upon receipt of the data from the communication terminal is configured to move display information representing the data received by the communication module so that a size of the display information is increased from a position at which the contact of the communication terminal is detected. The animation displayed upon transmission of the data to the communication terminal is configured to move display information representing the data transmitted to the communication module so that a size of the display information is decreased toward a position at which the contact of the communication terminal is detected.

Based on the accompanying drawings, a description will be made below of an embodiment to which a display processor and a display processing method are applied. Embodiments are not limited to this embodiment.

The display processor according to the embodiment displays a user interface screen on a display of a touch-panel type. The display processor detects contact with the user interface screen to execute a predetermined process. A mobile terminal is a portable communication terminal. As the mobile terminal, a device such as a smartphone can be used, but other dedicated devices may be used. For example, a device having a pen-like shape may be used.

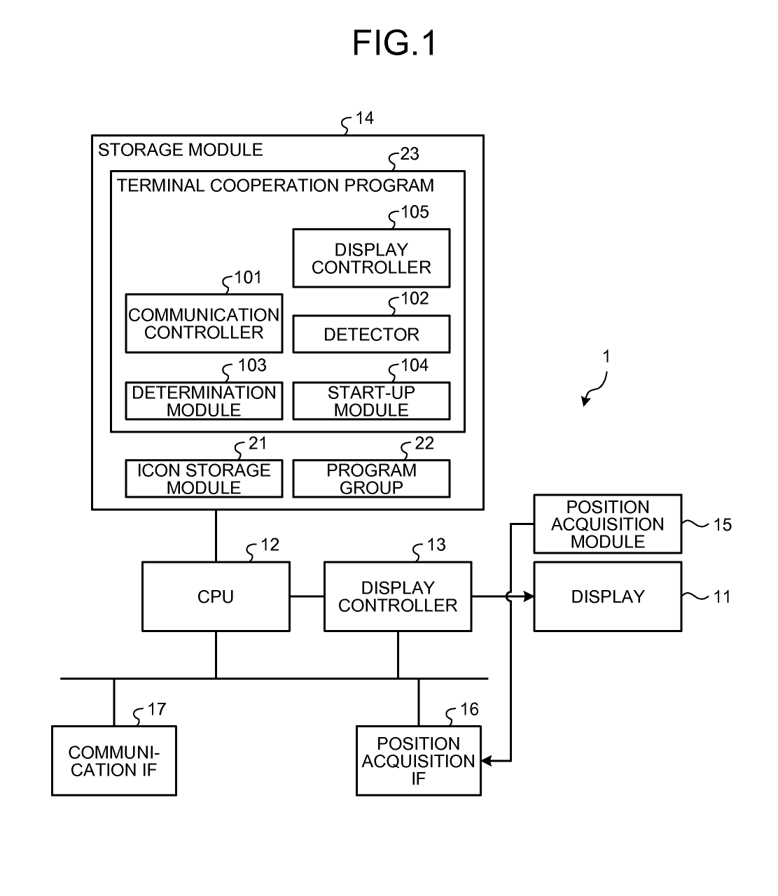

FIG. 1 is a hardware configuration diagram of a display processor 1 of the embodiment. As illustrated in FIG. 1, the display processor 1 comprises a display 11, a CPU 12, a display controller 13, a storage module 14, a position acquisition module 15, a position acquisition interface (IF) 16, and a communication interface (IF) 17.

The display 11 is composed of a liquid crystal display panel and other components, and displays the user interface screen for a user. The CPU 12 controls the entire display processor 1. According to the control from the CPU 12, the display controller 13 converts information and the user interface screen into a form of an image, and draws the image on the display 11.

The position acquisition module 15 acquires position coordinates in contact with the display 11. The position acquisition module 15 is composed of a touch sensor film attached to a surface of the display 11. Sensors are arranged in the X-axis and Y-axis directions on the touch sensor film. When the user touches the screen with a hand, a finger, the mobile terminal, or the like, the touch sensor film detects such contact, and outputs a detection signal comprising the contacted position coordinates to the position acquisition IF 16. Not only an actual contact, but also a state in which an object almost touches the display 11 may be regarded as the contact.

The position acquisition IF 16 outputs the detection signal (comprising the position coordinates detected by the touch sensor film) received from the position acquisition module 15 to the CPU 12.

The position acquisition module 15 may be an optical touch sensor. The optical touch sensor may detect an existence of an object by detecting whether light is transmitted or shielded, or may use a camera to detect the existence of the object from an image taken by the camera.

While, for example, a television display device equipped with a touch panel can be considered as the display processor 1 of the embodiment, the display processor 1 is not limited to such a device.

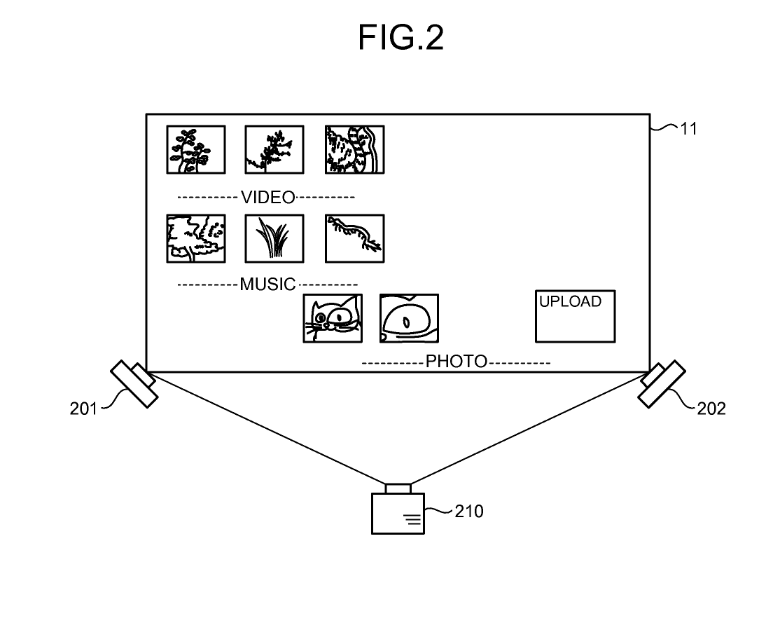

FIG. 2 is a diagram illustrating a modification of the embodiment that uses a projector 210 as the display 11 to display an image on a wall face. The example illustrated in FIG. 2 comprises optical touch sensors 201 and 202 as the position acquisition module for detecting a touched position when the wall face on which the image is projected is touched. Such a modification can also bring about the same effect using the same process as that of the embodiment. The position acquisition module is not limited to the optical touch sensors 201 and 202. Imaging cameras or the like may be used, or a touch sensor film may be used in the same manner as the embodiment, as the position acquisition module.

The display processor is also not limited to a device comprising therein a display device, but only needs to be a device that performs display processing. The display processor may be, for example, a set-top box or a computer externally connected to a display device comprising a touch sensor. The display device comprising a touch sensor is well-known as a monitor of a computer, and feeds, for example, a signal from the touch sensor to the display processor via a USB terminal.

Referring back to the embodiment illustrated in FIG. 1, the communication IF 17 is an interface that transmits and receives data between terminals and the display processor 1. For example, the communication IF 17 transmits and receives data to and from the mobile terminal via Bluetooth (registered trademark) or a wireless LAN, and performs Internet communication via the wireless LAN.

The storage module 14 is composed of storage media, such as a ROM and a RAM, that can store therein information, and comprises an icon storage module 21, a program group 22, and a terminal cooperation program 23.

The icon storage module 21 stores therein, in a manner associated with each other, image data of icon parts displayed on the user interface screen, programs that execute processing when the icons are touched, and position information that indicates display positions of the icon parts on the user interface of the display 11.

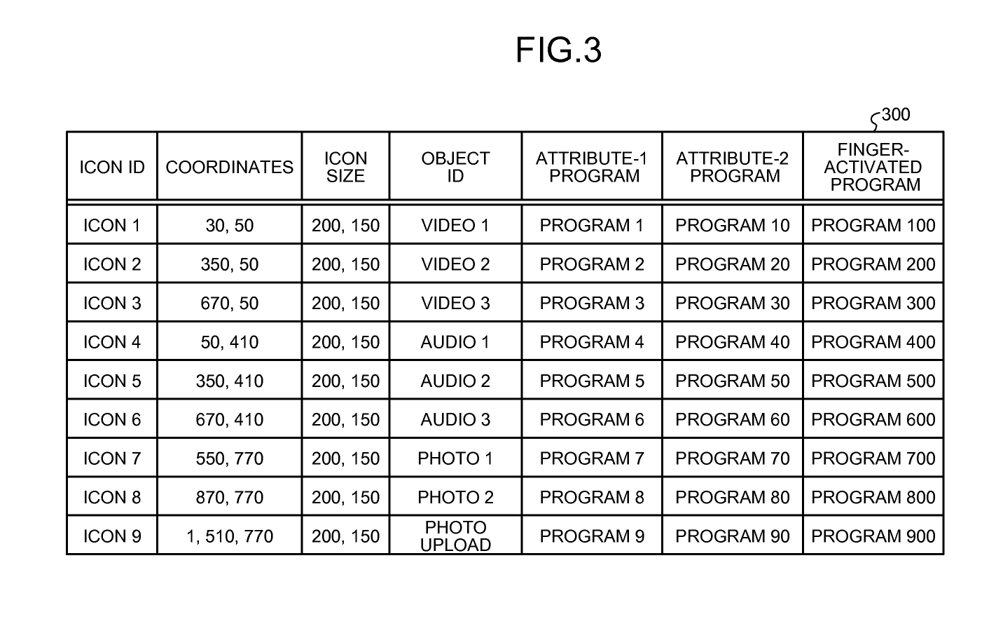

FIG. 3 is a diagram illustrating a data structure of an icon data table 300 stored in the icon storage module 21. As illustrated in FIG. 3, the icon data table 300 stores therein, in a manner associated with one record: an icon ID that is identification information of an icon; (position) coordinates that represent an example of a position when displayed on the display 11; an icon size; an object ID that specifies the image data used for the icon; and the programs each of which is started for each attribute of a terminal.

The image data of the icon specified by the object ID is drawn in the position indicated by the (position) coordinates on the display 11 according to the control of the CPU 12. The icon data table 300 according to the present embodiment stores therein, as the programs started when the icon is touched, three types of programs: an attribute-1 program for a case in which a touching mobile terminal has an attribute 1, an attribute-2 program for a case in which the touching mobile terminal has an attribute 2, and a finger-activated program for a case in which an object (such as a finger of the user) other than a mobile terminal comes in contact, in a manner associated with the icon ID.

The term “programs” is not limited to those having executable codes different from each other. The same executable code passing different arguments is also expressed as different programs. For example, the term also applies to those that all start web browsers but pass URLs different from each other, and to a message display program that passes different messages.

Referring back to FIG. 1, the program group 22 stores therein the programs executed by the display processor 1. For example, the program group 22 comprises the attribute-1 programs, the attribute-2 programs, and the finger-activated programs described above.

The terminal cooperation program 23 comprises a communication controller 101, a detector 102, a determination module 103, a start-up module 104, and a display controller 105, and performs control for starting the programs included in the program group 22 when the contact with the display 11 is detected.

The communication controller 101 establishes communication with a mobile terminal, and transmits and receives data to and from the mobile terminal. For example, the communication controller 101 receives attribute information indicating the attribute of the mobile terminal from the mobile terminal. The communication controller 101 also receives an acceleration detection signal indicating acceleration generated at the mobile terminal and an inclination detection signal.

The detector 102 detects the contact with a display area of the display 11 based on the detection signal received from the position acquisition module 15 via the position acquisition IF 16. The detector 102 also detects the position coordinates where the contact has occurred in the display area of the display 11.

The determination module 103 identifies the mobile terminal that has touched the display 11 based on the time when the detector 102 detected the contact and the time when the communication controller 101 received the acceleration detection signal. In the present embodiment, if the time difference between the time when the detector 102 detected the contact and the time when the communication controller 101 received the acceleration detection signal is within a predetermined threshold period, the mobile terminal from which the acceleration detection signal was sent is determined to be the touching terminal. The threshold period is determined depending on the mode of implementation.

Further, the determination module 103 identifies a program to be started, based on the attribute of the identified mobile terminal, the icon data table 300, and the position coordinates comprised in the acceleration detection signal. This can start the program in accordance with the attribute of the mobile terminal.

The start-up module 104 starts the program identified by the determination module 103. For example, in the example illustrated in FIG. 3, when contact with “Icon1” is detected, and if the mobile terminal corresponds to an “attribute-1 program”, “Program 1” corresponding to the attribute 1 is started. The position coordinates of the position touched by the mobile terminal need not coincide or overlap with the position coordinates corresponding to the icon. For example, the start-up module 104 may start a program associated with the icon when these position coordinates are close to each other at a distance within a predetermined value.

When the communication controller 101 transmits or receives data represented by the icon to or from the mobile terminal after the determination module 103 has determined that the contact of the mobile terminal (portable communication terminal) with the icon is detected, the display controller 105 displays, in the display area of the display 11, an animation that moves the icon with respect to the position serving as a reference where the contact of the mobile terminal has been detected.

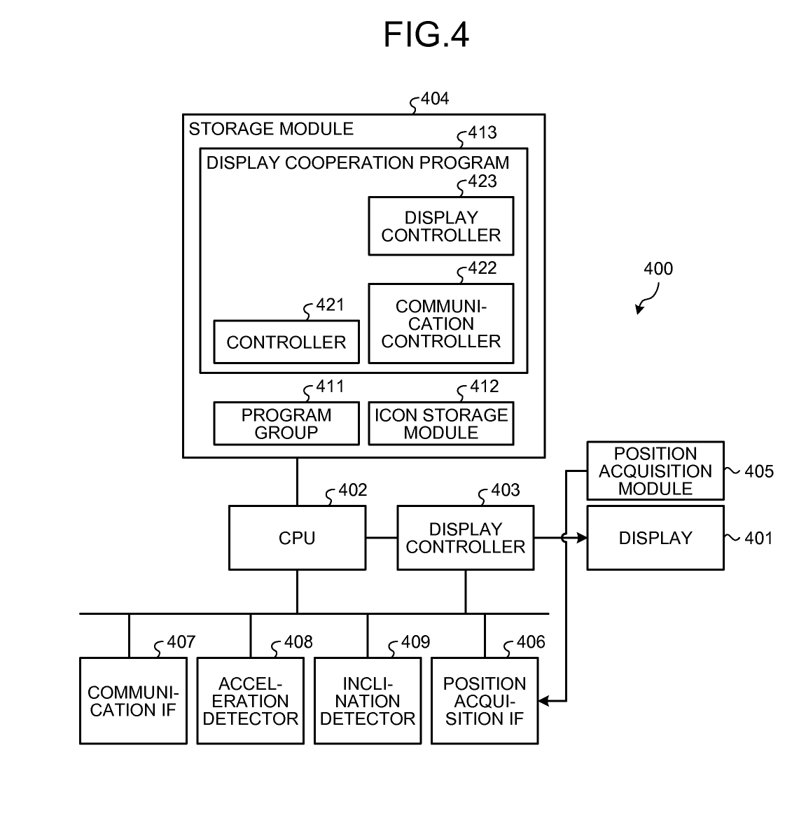

FIG. 4 is a diagram of a hardware configuration of a mobile terminal 400 of the embodiment. As illustrated in FIG. 4, the mobile terminal 400 comprises a display 401, a CPU 402, a display controller 403, a storage module 404, a position acquisition module 405, a position acquisition interface (IF) 406, a communication interface (IF) 407, an acceleration detector 408, and an inclination detector 409.

The display 401, the CPU 402, the display controller 403, the position acquisition module 405, the position acquisition IF 406, and the communication IF 407 comprised by the mobile terminal 400 perform the same processes as those of the display 11, the CPU 12, the display controller 13, the position acquisition module 15, the position acquisition IF 16, and the communication IF 17 comprised by the display processor 1. Thus, the description thereof will be omitted. The display 401 of the mobile terminal 400 according to the present embodiment is an example having a smaller screen size than that of the display 11 of the display processor 1.

The acceleration detector 408 detects acceleration from an acceleration sensor provided in the mobile terminal 400, and outputs the acceleration information to the CPU 402.

The inclination detector 409 detects an inclination from an inclination sensor provided in the mobile terminal 400, and outputs the inclination information to the CPU 402.

The storage module 404 is composed of storage media, such as a ROM and a RAM, that can store therein information, and comprises an icon storage module 412, a program group 411, and a display cooperation program 413.

In the same manner as the icon storage module 21 of the display processor 1, the icon storage module 412 stores therein, in a manner associated with each other, image data of icons displayed on a user interface screen, programs that execute processing when the icons are touched, and position information that indicates display positions of the icon on the user interface of the display 401.

The program group 411 stores therein programs that can play or display data (such as video data, audio data, and photo data) on the mobile terminal 400.

The display cooperation program 413 comprises a controller 421, a communication controller 422, and a display controller 423, stays resident in the mobile terminal 400, and performs control for cooperating with the display processor 1.

When data is to be sent to the display processor 1, the controller 421 sets data played or displayed by the program group 411 as the data to be sent.

When communication with the display processor 1 is established, the communication controller 422 performs control to transmit the attribute information indicating the attribute of the mobile terminal 400. When performing the control to transmit the data to the display processor 1, the communication controller 422 also performs control to transmit the data set by the controller 421.

The attribute information comprises, for example, a model name of the mobile terminal 400, a terminal type such as camera or audio player, a format of the set data, the inclination information detected in the inclination detector 409 of the mobile terminal 400, and terminal authentication information.

When the communication controller 422 receives data from the display processor 1, the display controller 423 displays an animation in which an icon representing the data received by the communication controller 422 moves from the outside of a display area of the display 401. When the communication controller 422 transmits data to the display processor 1, the display controller 423 displays an animation in which an icon representing the data sent by the communication controller 422 moves out of the display area of the display 401.

The data is sent and received between the above-described display processor 1 and the mobile terminal 400. The present embodiment performs the transmission and reception of data triggered by an operation to the user interface screen of the display processor 1.

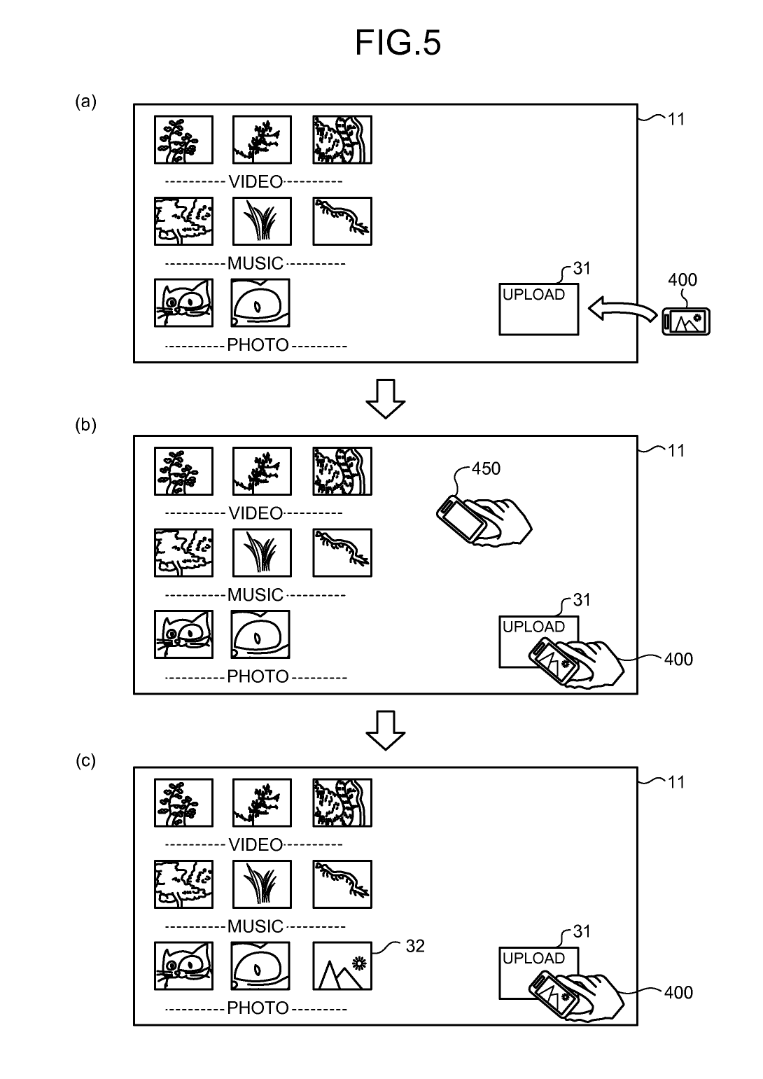

FIG. 5 is a diagram illustrating an example of the user interface screen when the terminal cooperation program 23 is executed in the display processor 1 of the present embodiment. As illustrated in FIG. 5(a), the display 11 of the display processor 1 displays three pieces of video data, three pieces of music data, and two pieces of photo data stored in the storage module 14 with respective icons of different types. The display 11 also displays an upload icon 31 that serves as a trigger for uploading data selected on the mobile terminal 400. The present embodiment assumes that, when data in the mobile terminal 400 is to be uploaded (at the stage illustrated in FIG. 5(a)), the data has been selected.

A description will be made of a case in which the mobile terminal 400 among a plurality of mobile terminals 400 and 450 touches the user interface screen of the display 11. The display processor 1 according to the present embodiment identifies the mobile terminal 400 as a cooperating terminal, and uploads video data that is set. An operation performed in that case will be described.

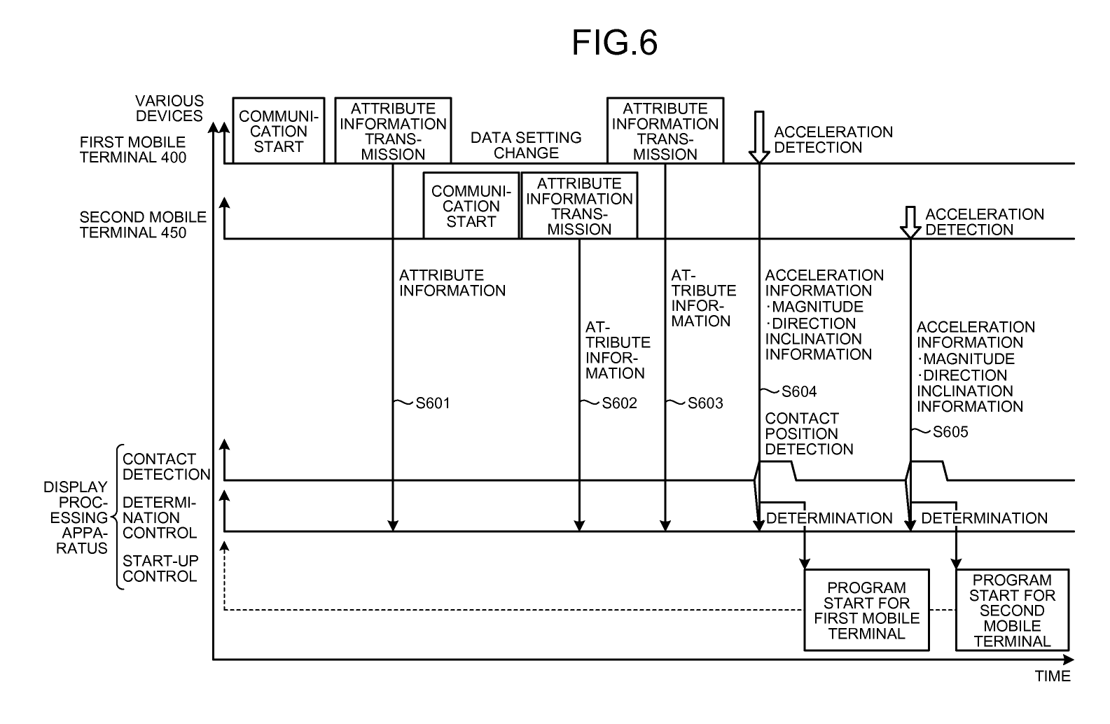

FIG. 6 is a diagram illustrating a timing chart of when cooperative processing between the display processor 1 and the mobile terminal 400 is executed.

The mobile terminals 400 and 450 start communication by coming close to the display processor 1. The present embodiment exemplifies communication via the wireless LAN. The mobile terminals 400 and 450 enter the same LAN area as that of the display processor 1, and thus, the display processor 1 and each of the mobile terminals 400 and 450 acquire IP addresses thereof from each other.

The display processor 1 receives the attribute information indicating the terminal attribute of each of the mobile terminals 400 and 450 from each of them (S601 and S602).

The example of FIG. 5(b) illustrates a state in which the first mobile terminal 400 is placed on the upload icon 31 of the display 11, and the second mobile terminal 450 exists in a position apart from the display 11 of the display processor 1. The second mobile terminal 450 may be, for example, in a bag of another person where the second mobile terminal 450 can communicate with the display processor 1 but is not located near the display processor 1. In this case, the display processor 1 receives the attribute information of both of the first and the second mobile terminals 400 and 450.

Referring back to FIG. 6, the first or the second mobile terminal 400 or 450 according to the present embodiment transmits the attribute information each time a setting of the first or the second mobile terminal 400 or 450 is changed (for example, each time the set data is changed) (for example, S603). The present embodiment does not limit the timing of transmission of the attribute information. For example, the attribute information may be sent to the display processor 1 at regular intervals.

Suppose that the display processor 1 receives the attribute information of the first or the second mobile terminal 400 or 450, and then the first or the second mobile terminal 400 or 450 receives a response indicating that the attribute information has been appropriately received. In that case, the first or the second mobile terminal 400 or 450 may display a message indicating that a mutual operation with the display processor 1 is now allowed on a screen comprised in the terminal.

As soon as the first mobile terminal 400 is placed on the upload icon 31, the communication controller 422 of the first mobile terminal 400 transmits the acceleration information detected by the acceleration detector 408 as an acceleration detection signal to the display processor 1 (S604).

Based on the detection signal (comprising the position coordinates) sent from the position acquisition module 15, the detector 102 of the display processor 1 detects that an object touches the neighborhood of, or a position very close to, the upload icon 31.

If the time when the detection signal was received is very close (within the predetermined threshold period) to the time when the acceleration detection signal was received from the first mobile terminal 400, the determination module 103 determines that the first mobile terminal 400 that sent the acceleration detection signal has touched the display 11, and identifies the first mobile terminal 400 as a cooperation target.

Then, with reference to the icon data table 300, the determination module 103 identifies, based on the attribute of the first mobile terminal 400, a program to be executed among a plurality of programs associated with the upload icon 31.

The start-up module 104 starts the program identified by the determination module 103. The started program transmits and receives data to and from the first mobile terminal 400 via the communication IF 17.

Thereafter, when the mobile terminal 450 is placed on the upload icon 31, the detector 102 detects the contact of the mobile terminal 450 by receiving the detection signal (comprising the position coordinates) via the position acquisition module 15. The detector 102 also acquires the contacted position coordinates. Then, the communication controller 101 receives the acceleration detection signal from the mobile terminal 450 (S605). The determination module 103 identifies the mobile terminal 450 touching the upload icon 31, and performs the same processing as that performed when the mobile terminal 400 touches the icon.

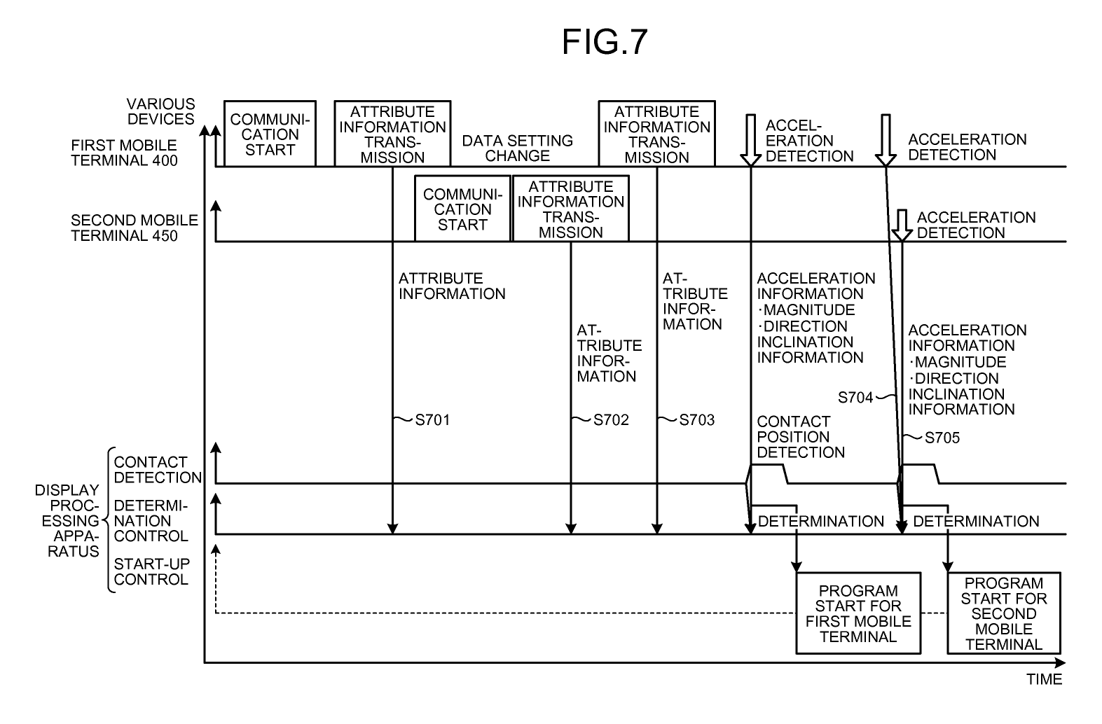

FIG. 7 is a diagram illustrating a case in which the time of the acceleration detection signal received from the first mobile terminal 400 and the time of the acceleration detection signal received from the second mobile terminal 450 are very close (within the predetermined threshold period) to the time when the detection signal is received. In the example illustrated in FIG. 7, the communication is started and the attribute information is sent (S701, S702, and S703) in the same manner as in the example illustrated in FIG. 6.

Thereafter, the communication controller 101 of the display processor 1 receives the acceleration detection signal from the first mobile terminal 400 and the acceleration detection signal from the second mobile terminal 450 almost at the same time (S704 and S705). In other words, the acceleration detection signals are received from the first mobile terminal 400 and the second mobile terminal 450 within the predetermined threshold period after the detector 102 has detected the contact.

For example, there can be a case in which the time when the mobile terminal 400 touches the display 11 of the display processor 1 almost coincides with the time when the mobile terminal 450 in the bag bumps together with the bag against something to generate acceleration. There can also be a case in which, for example, while a user performs an operation completely different from that of the first mobile terminal 400 on the second mobile terminal 450, the user strongly hits the screen of the second mobile terminal 450 at the same time as when the first mobile terminal 400 touches the display 11 of the display processor 1.

To avoid performing transmission and reception control of data with respect to a wrong terminal when the determination module 103 has identified a plurality of touching terminals, it is possible to refrain from transmitting or receiving the data to or from the identified mobile terminals 400 and 450, and prompt the user to touch the terminal again by displaying a message such as “Try touching again”. This can achieve transmission and reception of data to and from a mobile terminal desired by the user.

The operation is not limited to prompting the user to try touching again when the determination module 103 has identified a plurality of touching terminals. Both terminals may be regarded as touching, and corresponding programs may be executed for both of the terminals. In this manner, the operation is determined depending on the mode of implementation.

FIG. 5(c) illustrates the screen example after the upload is finished. After the upload is finished, the program started by the start-up module 104 first determines the type of the uploaded data, that is, whether the data is video, music, or photo data, and assigns the data with an appropriate icon according to the determination result. The screen example illustrated in FIG. 5(c) is an example in which photo data (an example of image data) has been uploaded. This additionally displays an icon 32 indicating the photo data uploaded from the first mobile terminal 400 in the area in which photo data is arranged.

In the present embodiment, when data is uploaded from the mobile terminal 400, the display controller 105 displays an animation in which the data comes out from a position where the mobile terminal 400 has been detected.

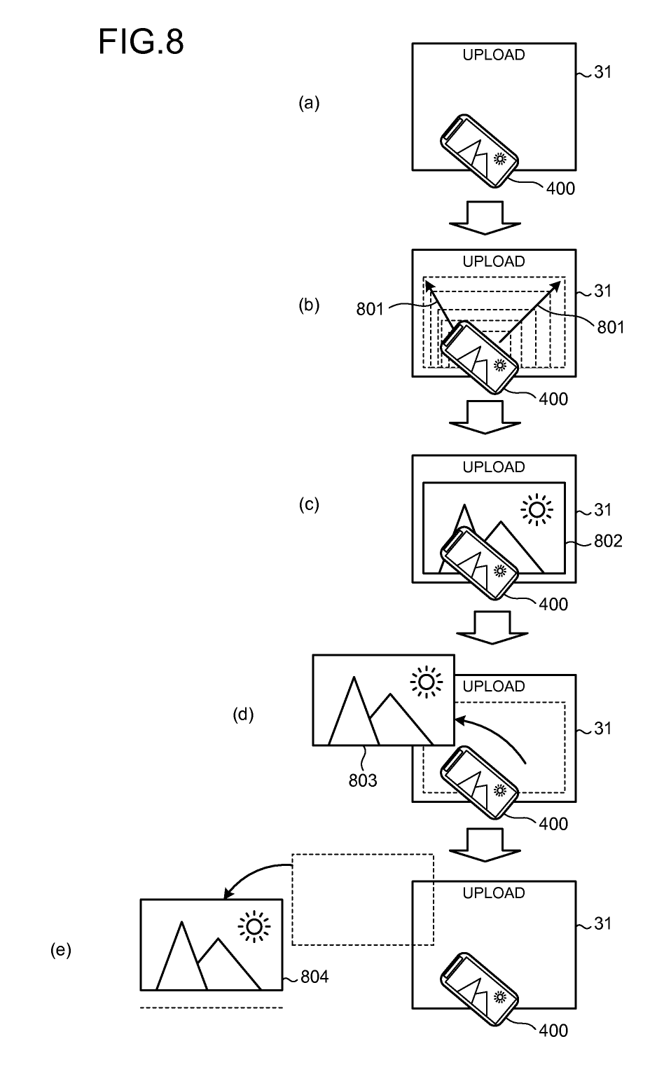

FIG. 8 is a diagram illustrating an example of screen transitions by display control of the display controller 105. FIG. 8(a) illustrates a situation in which the mobile terminal 400 is placed on the upload icon 31. The mobile terminal 400 is assumed to have already selected the data to be uploaded.

As illustrated in FIG. 8(b), the display controller 105 performs display in which an icon for the data to be uploaded is given an enlarging movement 801 corresponding to the upload state of the data with respect to the position where the mobile terminal 400 has been detected. The icon for the data is uploaded before the data is uploaded. The display controller 105 performs the display control so as to enlarge the icon based on the percentage of the data completed to be uploaded.

In the example illustrated in FIG. 8(b), the enlarging movement is performed with respect to the position serving as a center where the mobile terminal 400 is placed. Thus, the display controller 105 varies the enlarging movement depending on the position where the mobile terminal 400 is placed.

Finishing the upload of the data causes the display controller 105 to display an icon 802 for the data completed to be uploaded in the upload icon 31, as illustrated in FIG. 8(c).

Thereafter, as illustrated in FIG. 8(d), the display controller 105 starts to display an animation in which an icon 803 is moved to a storage location corresponding to the type of the data represented by the icon.

As illustrated in FIG. 8(e), the display controller 105 moves an icon to the storage location, and then finishes the movement of the icon 804.

In this manner, the display controller 105 according to the present embodiment displays the animation of moving the icon corresponding to the state of receiving of the data by the display controller 105 with respect to the position serving as a reference where the mobile terminal 400 has been detected. The present embodiment does not limit the mode of the animation display to the example illustrated in FIG. 8.

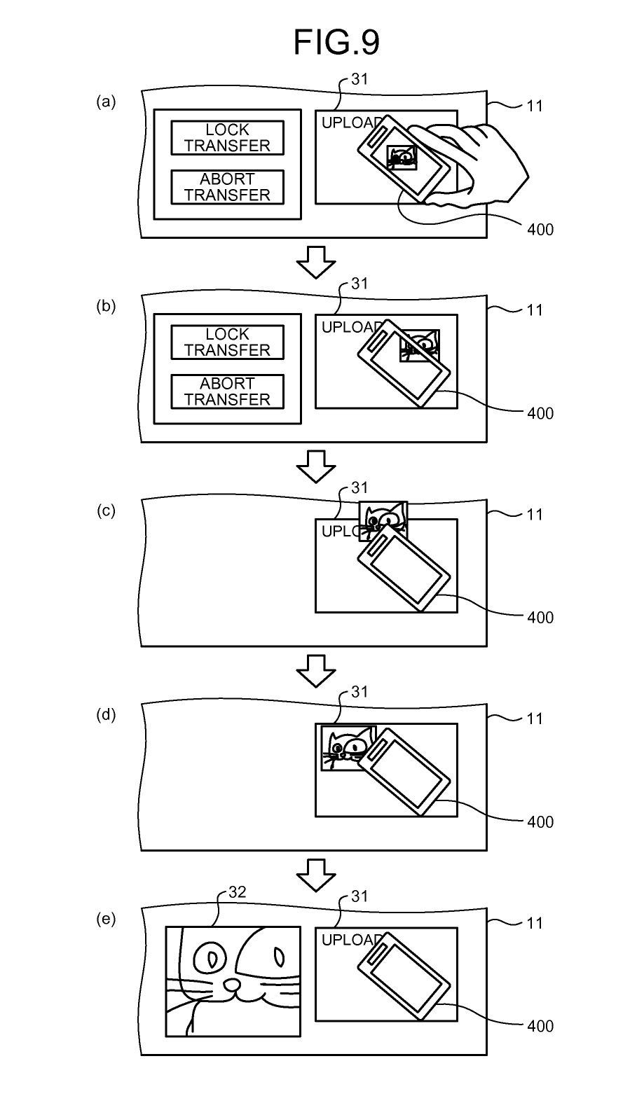

As another mode, for example, a mode illustrated in FIG. 9 is possible. FIG. 9 is a diagram illustrating an example of screen transitions by display control of the display controller 105 according to a modification of the embodiment. As illustrated in FIG. 9(a), photo data stored in the mobile terminal 400 is displayed as an icon on the screen of the mobile terminal 400. Data transfer starts when the mobile terminal 400 touches the display 11 of the display processor 1.

Then, as illustrated in FIGS. 9(b) to 9(d), the display controller 105 performs an animation that changes the percentage of the displayed icon corresponding to the degree of progress of the data transfer, specifically, the percentage of the amount of data completed to be transferred to a total amount of the data. The percentage of the displayed icon on the side of the display controller 105 increases as the upload progresses.

In a synchronized manner with this, the display controller 423 of the mobile terminal 400 performs an animation that changes the percentage of the displayed icon corresponding to the amount of untransferred data relative to the total amount of the data. The percentage of the displayed icon on the side of the display controller 423 of the mobile terminal 400 decreases as the upload progresses. This synchronizes the icons of the display processor 1 and the mobile terminal 400 with each other.

The position of the icon displayed by the display controller 105 is determined with respect to the position coordinates of the first mobile terminal 400 acquired by the position acquisition module 15 serving as reference coordinates. The icon displayed by the display controller 105 of the display processor 1 is positioned in the position of the icon displayed by the display controller 423 of the first mobile terminal 400. To synchronize the positions of the icons or the like, the mobile terminal 400 transmits in advance the inclination information to the display processor 1. The mobile terminal 400 also transmits in advance, for example, model information for identifying the mobile terminal 400, a screen size, and a resolution to the display processor 1.

Then, as illustrated in FIG. 9(b), the display processor 1 according to the modification may display the icon so as to come out from an outer side of the mobile terminal 400 identified from the inclination information and the model information (or the size of the mobile terminal 400) that have been received.

This combines a first portion of the icon displayed by the display controller 423 with a second portion of the icon displayed by the display controller 423. This allows the user to recognize the first and the second portions as one icon.

When the data transfer is completed, the display controller 423 displays the icon 32 indicating the data as illustrated in FIG. 9(e). Thereafter, the display controller 105 moves the icon 32 according to the type of the data.

The above-described display control performed by the display controller 423 allows the user to understand the communication status of the data.

When the contact of the first mobile terminal 400 with the display 11 is detected, the terminal cooperation program 23 may display a dialog for confirmation on the first mobile terminal 400 to ask the user for a confirmation of the operation, instead of immediately starting the data transfer. This can keep the data from being transferred against the intention of the user when a wrong determination is made as to whether the first mobile terminal 400 has made a touch.

When the display processor 1 has received the model information, the resolution, and the screen size of the mobile terminal 400, the display processor 1 may adjust the size of the icon so as to coincide with the size of the icon displayed on the mobile terminal 400. This can display the icons in the same size or almost the same size on the mobile terminal 400 and the display processor 1.

When the mobile terminal 400 has moved away from the display 11 during the data transfer, the data transfer between the display processor 1 and the mobile terminal 400 is stopped. Thus, the user can intuitively instruct the stop of the data transfer without performing a particular operation for canceling it.

The display controller 105 may display a dialog such as “Lock transfer” and “Abort transfer” as illustrated in FIGS. 9(a) and 9(b) before starting the data transfer or during the data transfer with the mobile terminal 400. If the display processor 1 has not accepted a selection on the dialog, the data transfer is stopped when the mobile terminal 400 is moved away from the display 11 after the transfer has started. If the display processor 1 has accepted a selection of “Lock transfer”, the data transfer is continued even after the mobile terminal 400 is moved away from the display 11. In this manner, the data transfer corresponding to a demand of the user can be achieved.

By accepting a selection of “Abort transfer”, the display processor 1 aborts the data transfer between the display processor 1 and the mobile terminal 400. In other words, if the selection of “Lock transfer” has been accepted, simply moving the mobile terminal 400 away from the display 11 does not stop the data transfer, but accepting the selection of “Abort transfer” from the user can abort the data transfer. This allows the user who has selected “Lock transfer” to abort the data transfer by selecting “Abort transfer” when the user wants to abort the data transfer.

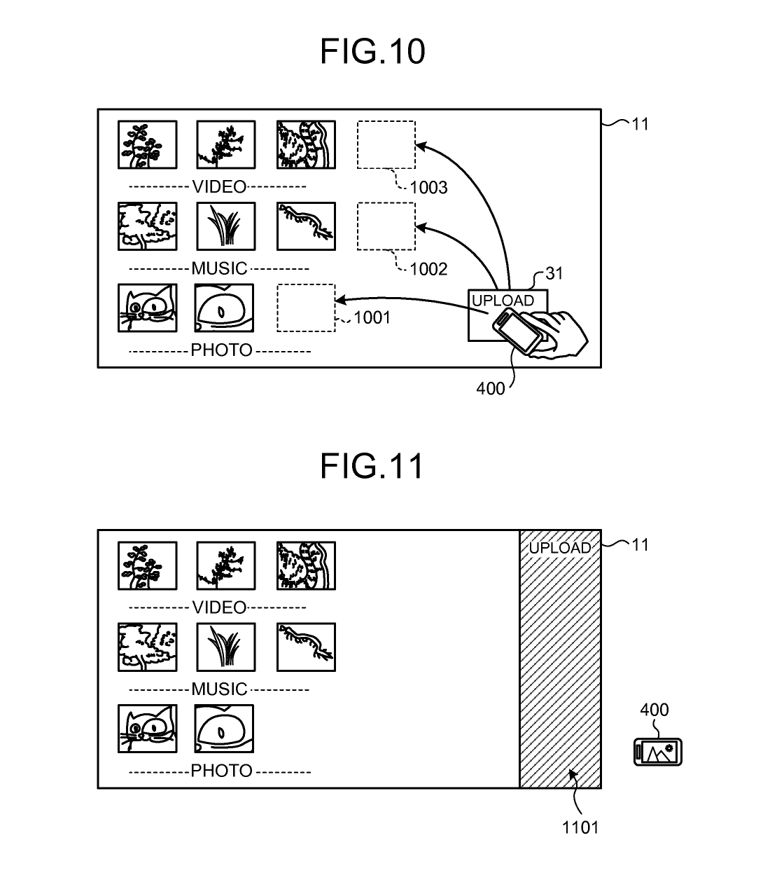

After the data transfer is completed, the display controller 105 displays an animation that moves the icon to a position corresponding to the type of the data. FIG. 10 is a diagram illustrating an example of destinations of icons moved by the display controller 105. As illustrated in FIG. 10, if the received data is video data, the display controller 105 moves the icon for the video data to a position 1003. If the received data is music data, the display controller 105 moves the icon for the music data to a position 1002. If the received data is photo data, the display controller 105 moves the icon for the photo data to a position 1001.

The present embodiment does not limit the area that starts an upload when being touched by the mobile terminal 400 to the upload icon 31. FIG. 11 is illustrates an example of the area that starts an upload according to a modification of the embodiment. The area only needs to be an area, such as an upload area 1101 of FIG. 11, in the display area of the display 11.

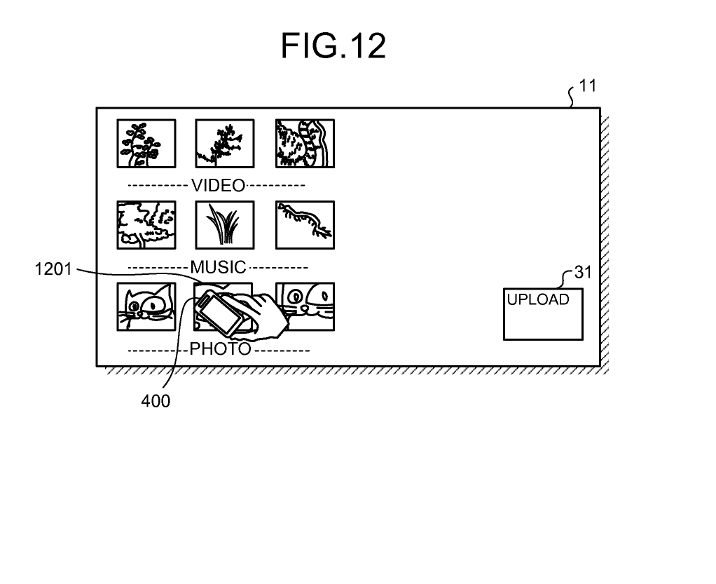

A description will be made of a case of downloading data from the display processor 1 to the mobile terminal 400. In the case of downloading data from the display processor 1 to the mobile terminal 400, touching an icon displayed on the display 11 with the mobile terminal 400 starts downloading data represented by the icon. FIG. 12 is a diagram illustrating placement of the mobile terminal 400 when the data is to be downloaded from the display processor 1. As illustrated in FIG. 12, placing the mobile terminal 400 on an icon 1201 starts downloading photo data represented by the icon 1201.

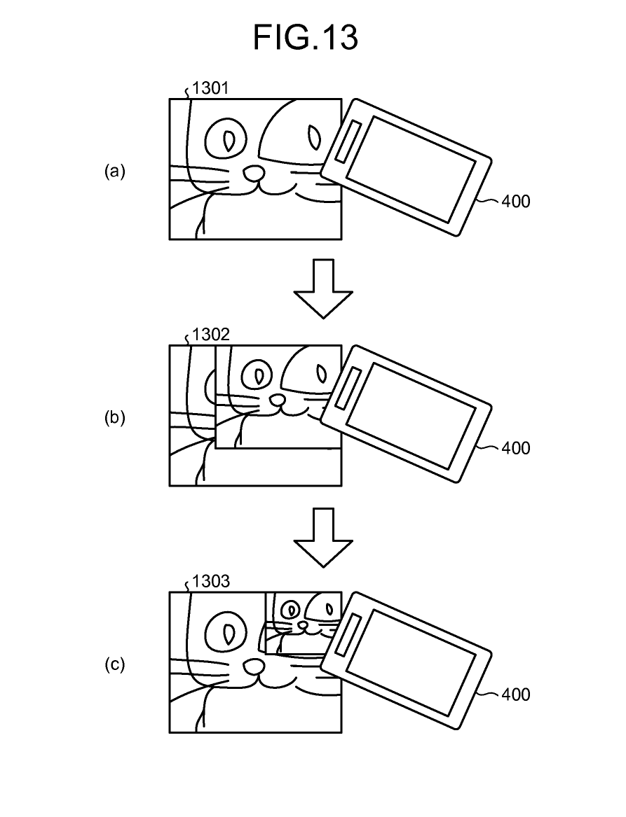

Also while the download is performed, the display controller 105 displays an animation in which the icon moves to the mobile terminal 400. FIG. 13 is a diagram illustrating an example of screen transitions performed in display control by the display controller 105 according to the present embodiment. As illustrated in FIG. 13(a), the mobile terminal 400 is placed on an icon 1301. This causes the detector 102 to detect the contact of the mobile terminal 400, and causes data represented by the icon 1301 touched by the mobile terminal 400 to be identified as data to be downloaded.

The display controller 105 performs the display control so as to move and reduce in size the icon 1301 with respect to the position serving as a center where the mobile terminal 400 is placed, corresponding to the download state between the display processor 1 and the mobile terminal 400.

Specifically, as illustrated by an icon 1302 of FIG. 13(b) and an icon 1303 of FIG. 13(c), the display controller 105 performs the display control so that the icon moves while being reduced in size as the download to the mobile terminal 400 progresses.

The display controller 105 according to the present embodiment performs the display control so that the icon representing the data to be downloaded moves toward the mobile terminal 400 while being reduced in size. In other words, the display controller 105 varies the animation of the reduction movement of the icon depending on the position of the mobile terminal 400.

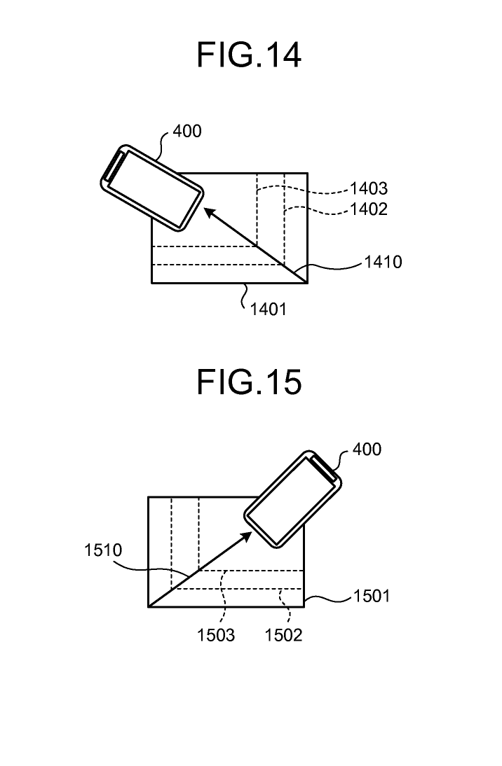

FIG. 14 is a diagram illustrating a reduction movement of an icon 1401 performed by the display controller 105 when the mobile terminal 400 is placed at the upper left of the icon 1401. As indicated by an arrow 1410 of FIG. 14, the icon is displayed so as to be reduced in size toward the mobile terminal 400 in the order of the icon 1401, an icon 1402, and an icon 1403.

FIG. 15 is a diagram illustrating a reduction movement of an icon 1501 performed by the display controller 105 when the mobile terminal 400 is placed at the upper right of the icon 1501. As indicated by an arrow 1510 of FIG. 15, the icon is displayed so as to be reduced in size toward the mobile terminal 400 in the order of the icon 1501, an icon 1502, and an icon 1503.

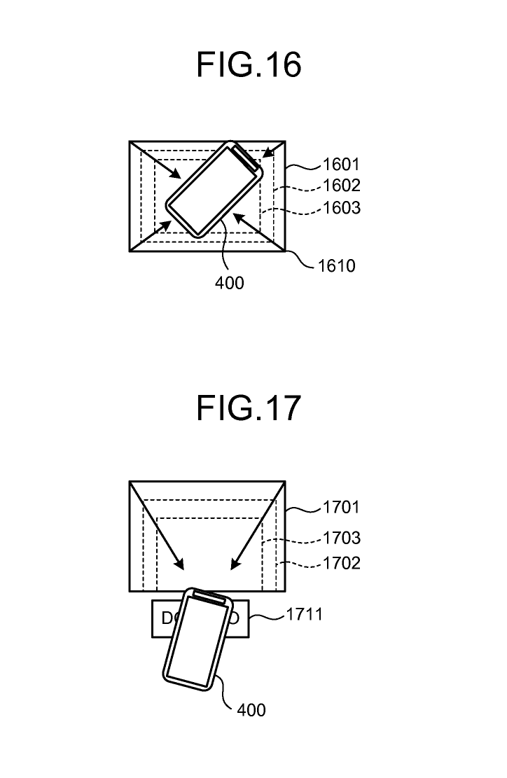

FIG. 16 is a diagram illustrating a reduction movement of an icon 1601 performed by the display controller 105 when the mobile terminal 400 is placed near the center of the icon. As indicated by an arrow 1610 of FIG. 16, the icon is displayed so as to be reduced in size toward the mobile terminal 400 in the order of the icon 1601, an icon 1602, and an icon 1603.

By displaying the above-described animation, the display controller 105 according to the present embodiment allows the user to visually understand that the data is being downloaded from the display processor 1 to the mobile terminal 400. Also, by reducing in size the icon corresponding to the state of the download, the display controller 105 allows the user to understand the degree of progress of the download.

The present embodiment does not limit the download and the upload to be started when the mobile terminal 400 touches an icon, but various modes are possible. For example, FIG. 17 is a diagram illustrating a modification of the embodiment that displays a download button 1711 for data represented by an icon 1701. The example illustrated in FIG. 17 starts downloading the data represented by the icon 1701 when the mobile terminal 400 touches the download button 1711. Also, in the case of such a modification, the display controller 105 displays an animation that reduces in size the icon toward the position touched by the mobile terminal 400 in the order of the icon 1701, an icon 1702, and an icon 1703.

While, in the present embodiment, the description has been made of the examples of enlarging and reducing in size the entire icon corresponding to the communication status of the data, various modes are possible. For example, the icon may be enlarged or reduced in size only in the vertical direction or the horizontal direction thereof toward the mobile terminal 400 to which the data is downloaded.

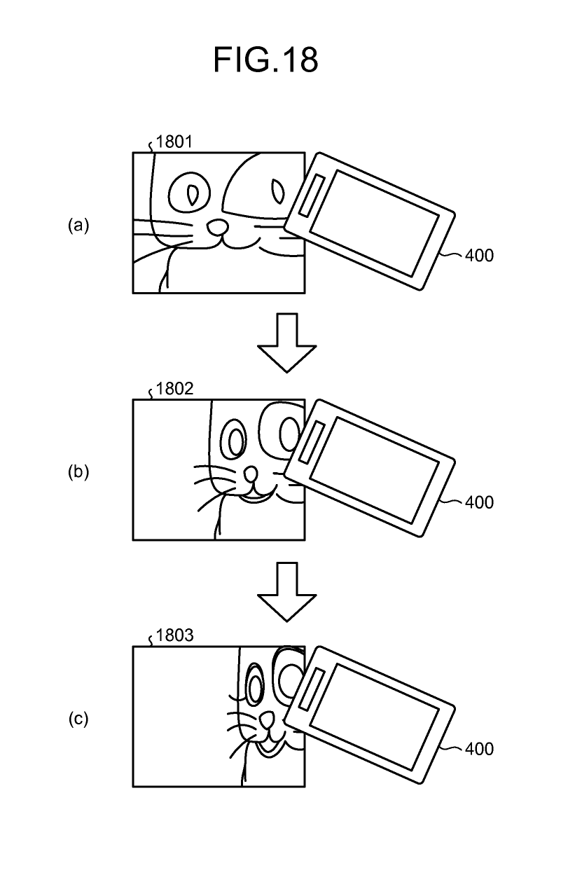

FIG. 18 is a diagram illustrating an example of screen transitions performed in display control by the display controller 105 according to a modification of the embodiment. As illustrated in FIG. 18(a), the mobile terminal 400 touches an icon 1801. This causes the detector 102 to detect the contact of the mobile terminal 400, and causes data represented by the icon 1801 touched by the mobile terminal 400 to be identified as data to be downloaded.

The display controller 105 performs the display control so as to move and reduce in size the icon 1801 only in the horizontal-axis direction thereof with respect to the position touched by the mobile terminal 400, corresponding to the download state between the display processor 1 and the mobile terminal 400.

Specifically, as illustrated by an icon 1802 of FIG. 18(b) and an icon 1803 of FIG. 18(c), the display controller 105 performs the display control so that the icon moves while being reduced in size only in the horizontal-axis direction thereof as the download to the mobile terminal 400 progresses. If the icon 1801 is composed of a plurality of images, the picture of the icon may vary corresponding to the download state. FIG. 18 represents an example of displaying an animation in which the content of the icon is gradually pressed flat so as to make the expression of a face in the icon tenser.

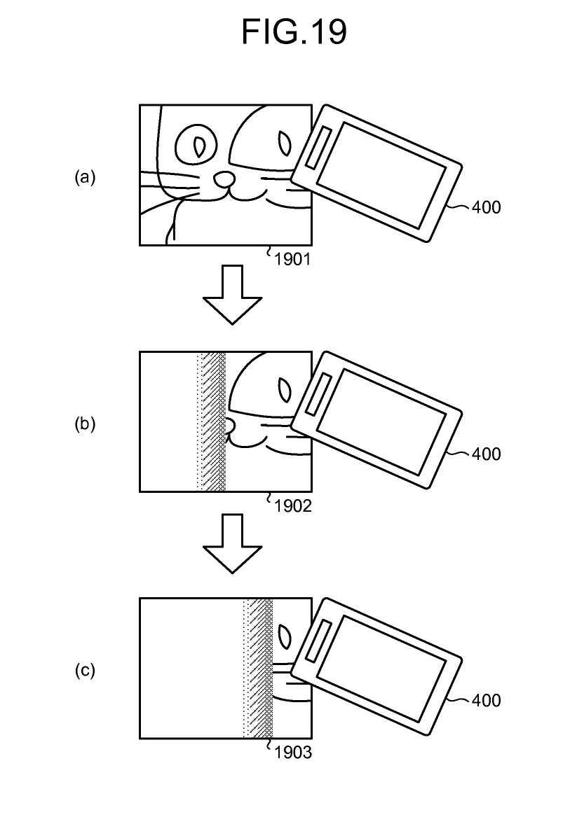

The icon is not limited to be animation-displayed by the reducing and enlarging control, but, for example, the color and/or luminance of the icon may be changed. FIG. 19 is a diagram illustrating an example of screen transitions with the luminance variation by the display controller 105 according to a modification of the embodiment. As illustrated in FIG. 19(a), the mobile terminal 400 touches an icon 1901. This causes the detector 102 to detect the contact of the mobile terminal 400, and causes data represented by the icon 1901 touched by the mobile terminal 400 to be identified as data to be downloaded.

The display controller 105 displays an animation that changes the luminance and the color of the icon 1901, with respect to the position touched by the mobile terminal 400 as a reference position, from an area farthest from the reference position, corresponding to the download state between the display processor 1 and the mobile terminal 400.

Specifically, as illustrated by an icon 1902 of FIG. 19(b) and an icon 1903 of FIG. 19(c), the display controller 105 displays an animation that gradually increases the luminance (changes the color to white) from a left side distant from the position touched by the mobile terminal 400 as the download to the mobile terminal 400 progresses. This produces an animation display in which the picture disappears with time. This in turn allows the user to perceive that the data represented by the icons 1901 to 1903 enters the mobile terminal 400.

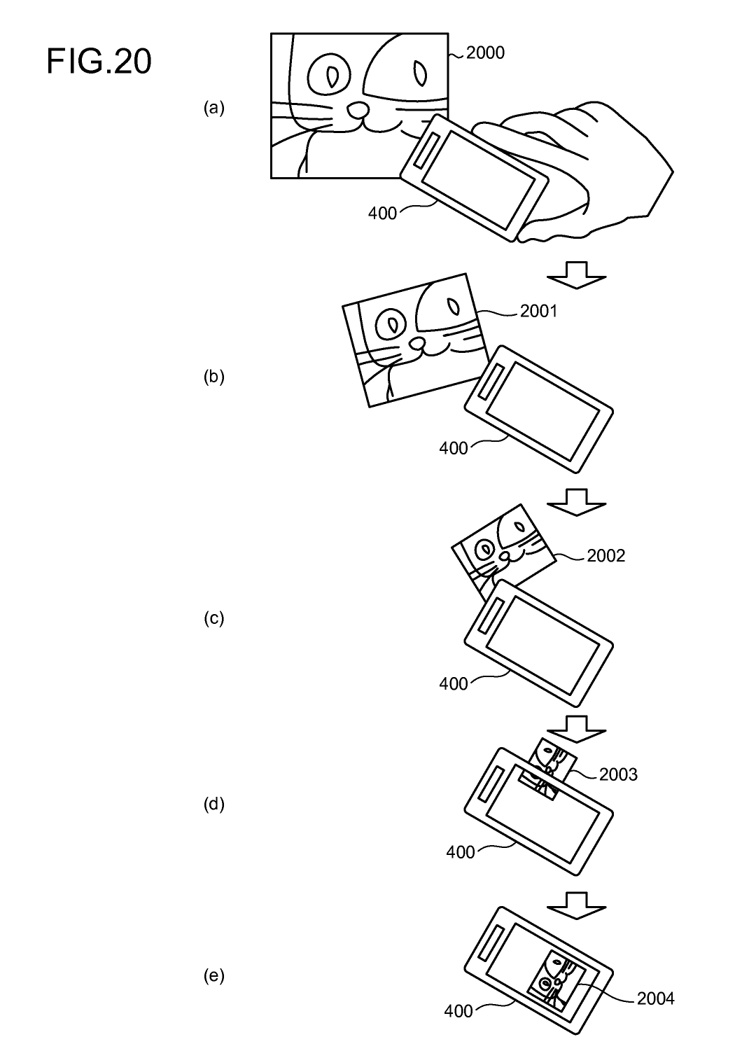

A description will be made of another mode of the animation displayed while the download is performed. FIG. 20 is a diagram illustrating an example of screen transitions by display control of the display controller 105 according to a modification of the embodiment. As illustrated in FIG. 20(a), the mobile terminal 400 touches an icon 2000. This causes the detector 102 to detect the contact of the mobile terminal 400, and causes data represented by the icon 2000 touched by the mobile terminal 400 to be identified as data to be downloaded.

Then, as illustrated by an icon 2001 of FIG. 20(b) and an icon 2002 of FIG. 20(c), the display controller 105 displays an animation that reduces in size the icon in accordance with the screen size and the resolution of the mobile terminal 400. The mobile terminal 400 has sent in advance the screen size and the resolution to the display processor 1. The display processor 1 may instead identify the screen size and the resolution based on the model information received from the mobile terminal 400.

As illustrated in FIG. 20(d), the display controller 105 displays an animation that moves an icon 2003 to the position where the mobile terminal 400 has been detected corresponding to the degree of progress of the data transfer, specifically, the percentage of the amount of data completed to be transferred to a total amount of the data.

When the download is completed, as illustrated in FIG. 20(e), the display controller 105 stops displaying the icon representing the data being downloaded, and the display controller 423 of the mobile terminal 400 displays an entire icon 2004 representing the data completed to be downloaded. This allows the user to understand that the download of the data is completed.

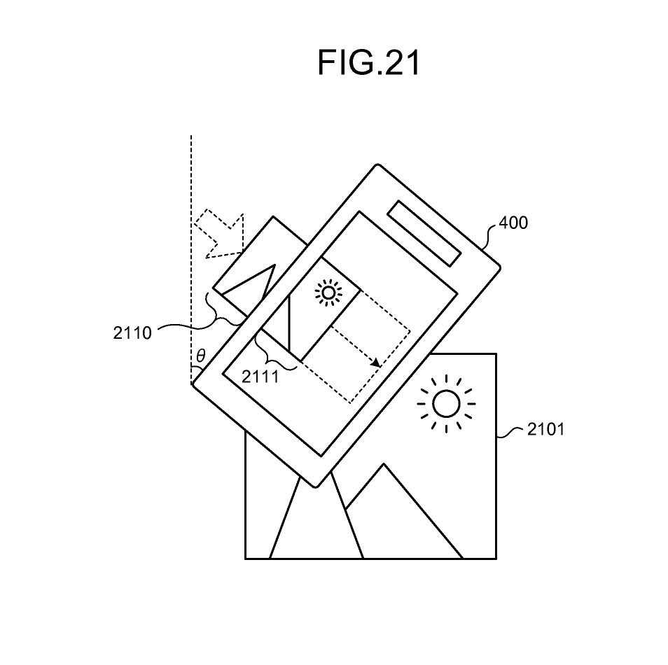

A description will be made of icons displayed by the display processor 1 and the mobile terminal 400 according to the modification during the download. FIG. 21 is a diagram illustrating a display mode of the display processor 1 and the mobile terminal 400 during the download.

The example illustrated in FIG. 21 assumes that the mobile terminal 400 has sent the inclination information 0, the screen size, and the resolution to the display processor 1. The display processor 1 has thereafter generated icon data to be displayed by the mobile terminal 400, and sent it to the mobile terminal 400. The display processor 1 has further notified the mobile terminal 400 of displaying an animation of inserting the icon from the left side.

First, the display controller 105 of the display processor 1 reduces in size an icon 2101 according to the screen data of the mobile terminal 400.

Thereafter, the display controller 105 of the display processor 1 rotates a reduced icon 2102 by the inclination 0. Thereafter, the display controller 105 displays an animation that moves a part 2110 of the rotated icon to the mobile terminal 400 with respect to a position serving as a reference point in the display 11 corresponding to the left side of the mobile terminal 400, corresponding to the percentage of the data not yet downloaded.

The display controller 423 of the mobile terminal 400 displays an animation of a part 2111 of the icon from the left side of the display area, corresponding to the percentage of the data completed to be downloaded.

The display controller 423 of the mobile terminal 400 and the display controller 105 of the display processor 1 varies the displayed icon corresponding to the download state. This allows the mobile terminal 400 and the display processor 1 to synchronize the display of the icons.

In the above example, the description has been made of the case in which the mobile terminal 400 touches the display area of the display processor 1. If, compared with this, contact with an icon displayed on the display 11 is detected but no acceleration detection signal is received from any mobile terminal (including the mobile terminal 400), the determination module 103 determines that an object (such as a hand or a finger) other than a mobile terminal touches the icon, and plays or displays data (such as video data or photo data) represented by the icon.

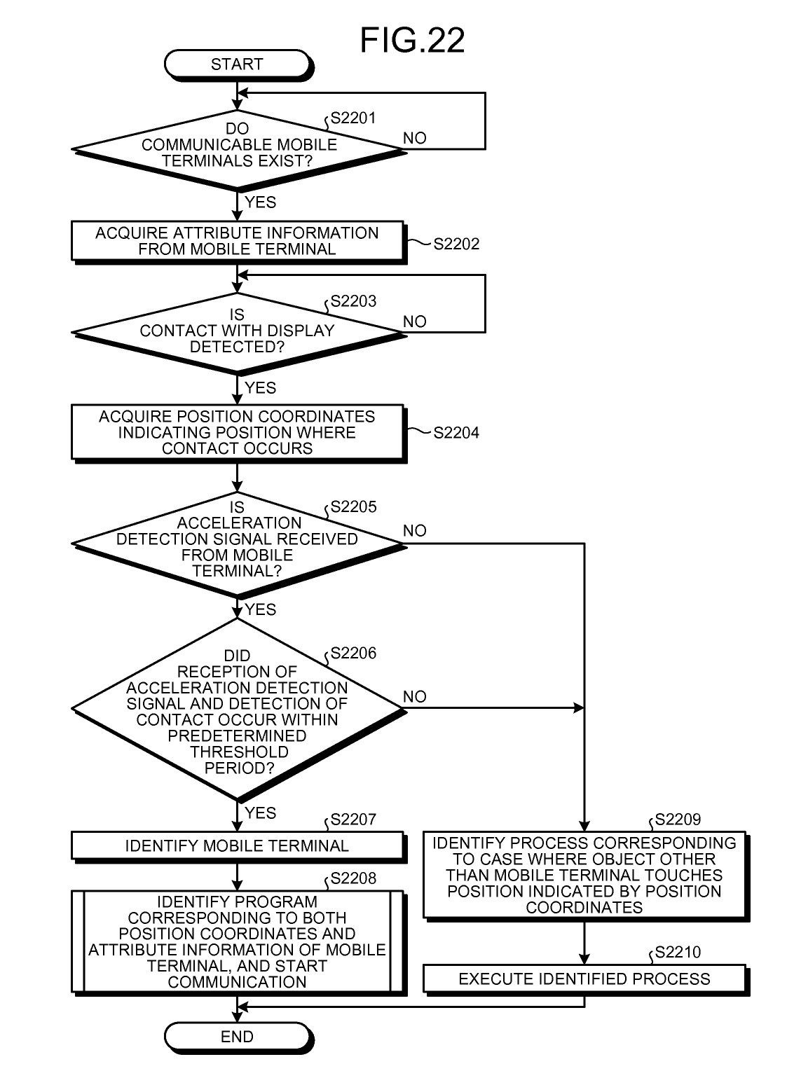

A description will be made of a process until communication with the mobile terminal 400 starts in the display processor 1 according to the present embodiment. FIG. 22 is a flowchart illustrating the above-mentioned process in the display processor 1 according to the present embodiment.

The communication IF 17 detects whether communicable mobile terminals exist (S2201). If no existence is detected (No at S2201), the communication IF 17 repeats the process at S2201 until communicable mobile terminals are detected. If the communication IF 17 detects communicable mobile terminals (Yes at S2201), the communication IF 17 starts communication with each of the detected mobile terminals. The terminal cooperation program 23 acquires attribute information of each of the mobile terminals via the communication IF 17 (S2202).

Thereafter, based on a detection signal from the position acquisition module 15, the detector 102 determines whether contact with the display 11 is detected (S2203). If the detector 102 determines that contact with the display 11 is detected (Yes at S2203), the detector 102 acquires, based on the detection signal, position coordinates where the contact is detected (S2204). If the detector 102 determines that contact with the display 11 is not detected (No at S2203), the process at S2203 is repeated.

Then, it is determined whether the communication controller 101 has received an acceleration detection signal from the mobile terminal via the communication IF 17 (S2205). If no acceleration detection signal has been received (No at S2205), it is assumed that the display 11 is touched not by the mobile terminal but by a human finger or the like, and a process (program) for the case in which a human finger or the like touches the position indicated by the position coordinates are identified (S2209). The start-up module 104 executes the identified process (program) (S2210). The identified process is, for example, playing or displaying of data (video data, music data, or photo data) associated with the icon existing in the touched position.

If the communication controller 101 has received the acceleration detection signal (Yes at S2205), the determination module 103 determines whether the time when the contact based on the detection signal was detected and the time when the acceleration based on the acceleration detection signal was generated at the mobile terminal lie within the predetermined threshold period, in other words, whether the occurrence times thereof are close to each other (S2206). If the determination module 103 determines that the occurrence times do not lie within the predetermined threshold period (No at S2206), the process is performed from S2209.

If the determination module 103 determines that the occurrence times lie within the predetermined threshold period (Yes at S2206), the determination module 103 assumes that the mobile terminal that sent the acceleration detection signal has come in contact, and identifies the mobile terminal as a target of data transmission and reception (S2207).

The determination module 103 identifies a program corresponding to the position coordinates where the contact has occurred and the attribute information of the mobile terminal serving as the target of data transmission and reception. The start-up module 104 starts the identified program. This starts the communication between the display processor 1 and the mobile terminal (S2208). At this time, processing according to the attribute information of the mobile terminal is performed. The attribute information of the mobile terminal may be acquired again at S2208.

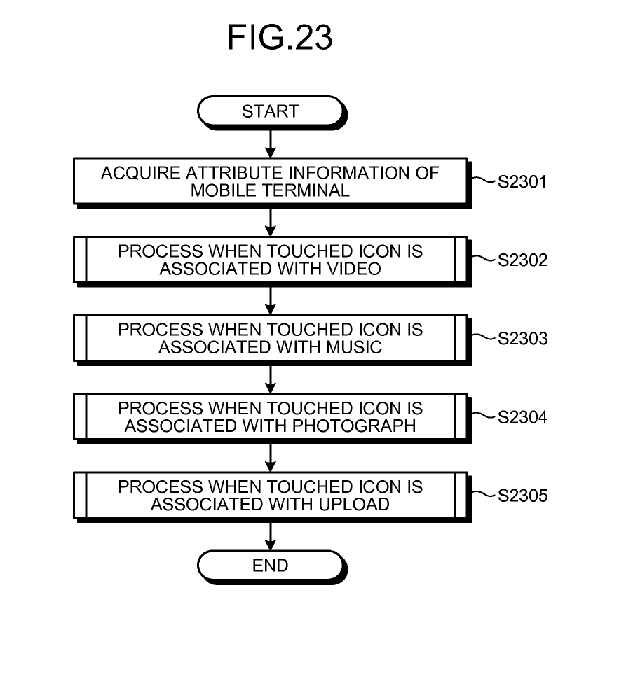

A description will be made of a process from the start of the program until the start of the communication indicated by S2208 according to the present embodiment. FIG. 23 is a flowchart illustrating the above-mentioned process in the display processor 1 according to the present embodiment.

First, the determination module 103 acquires the attribute information of the mobile terminal identified as the target of data transmission and reception (S2301). The attribute information includes information such as supported data formats, a screen size, available functions, and a communication system. The display processor 1 stores the acquired attribute information of the mobile terminal. The determination module 103 may acquire the attribute information via a network (including the Internet) or from a database in the display processor 1.

Then, the determination module 103 and the start-up module 104 perform processing for the case in which the icon touched (or existing near the touched position) is associated with a video (S2302). The data is transferred, for example, after being converted so as to be playable by the mobile terminal.

Then, the determination module 103 and the start-up module 104 perform processing for the case in which the icon touched (or existing near the touched position) is associated with music (S2303). The data is transferred, for example, after being converted so as to be playable by the mobile terminal.

Then, the determination module 103 and the start-up module 104 perform processing for the case in which the icon touched (or existing near the touched position) is associated with a photograph (S2304).

Then, the determination module 103 and the start-up module 104 perform processing for the case in which the icon touched (or existing near the touched position) is associated with the upload (S2305).

As described above, when the contact by the mobile terminal has occurred, the data indicated by the icon is transferred after being processed according to the type of the data. The communication method when the data is transferred may be changed based on whether the mobile terminal as a transfer destination can communicate via the wireless LAN or Bluetooth (registered trademark).

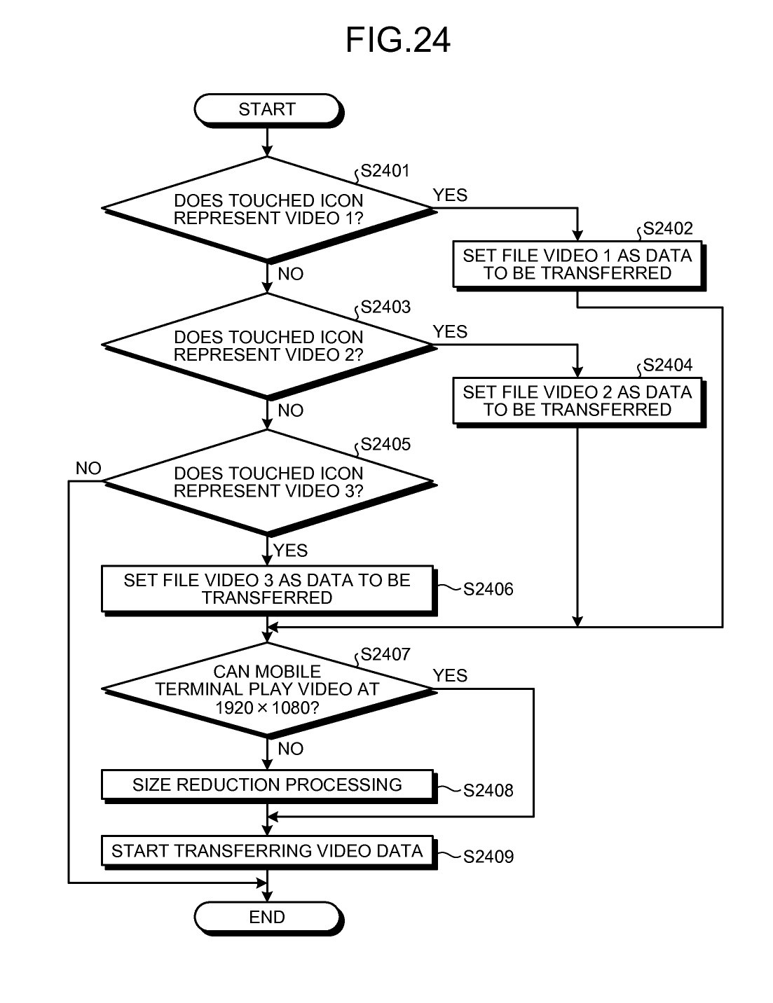

A specific process at S2302 will be described. FIG. 24 is a flowchart illustrating the process in the display processor 1 according to the present embodiment when the touched icon is associated with a video.

First, based on the position coordinates comprised in the detection signal, the determination module 103 determines whether the icon touched by the mobile terminal 400 represents a file Video1 (S2401). If the determination module 103 determines that the icon represents the file Video1 (Yes at S2401), the determination module 103 sets the file Video1 as data to be transferred (S2402). Thereafter, the process proceeds to a process at S2407.

If the determination module 103 determines that the icon touched by the mobile terminal 400 does not represent the file Video1 (No at S2401), the determination module 103 determines whether the touched icon represents a file Video2 (S2403). If the determination module 103 determines that the icon represents the file Video2 (Yes at S2403), the determination module 103 sets the file Video2 as data to be transferred (S2404). Thereafter, the process proceeds to the process at S2407.

If the determination module 103 determines that the icon existing in the touched position does not represent the file Video2 (No at S2403), the determination module 103 determines whether the touched icon represents a file Video3 (S2405). If the determination module 103 determines that the icon represents the file Video3 (Yes at S2405), the determination module 103 sets the file Video3 as data to be transferred (S2406). Thereafter, the process proceeds to the process at S2407. If the determination module 103 determines that the icon does not represent the file Video3 (No at S2405), no particular processing with respect to a video is performed.

After S2402, S2404, or S2406, the determination module 103 determines, based on the acquired attribute information, whether the mobile terminal as a destination of the video data can play the data at a display size of 1920×1080 (S2407). The files Video1, Video2, and Video3 are assumed to have a resolution of 1920×1080.

If the determination module 103 determines that the mobile terminal can play the data at the display size of 1920×1080 (Yes at S2407), the process proceeds to S2409. If the determination module 103 determines that the mobile terminal cannot play the data at the display size of 1920×1080 (No at S2407), the start-up module 104 starts a size reduction program that reduces in size the video data, and the size reduction program reduces the video data to 640×480 (S2408).

After S2407 and S2408, the start-up module 104 starts a video transfer program. The video transfer program starts transferring the video data set as the data to be transferred (S2409).

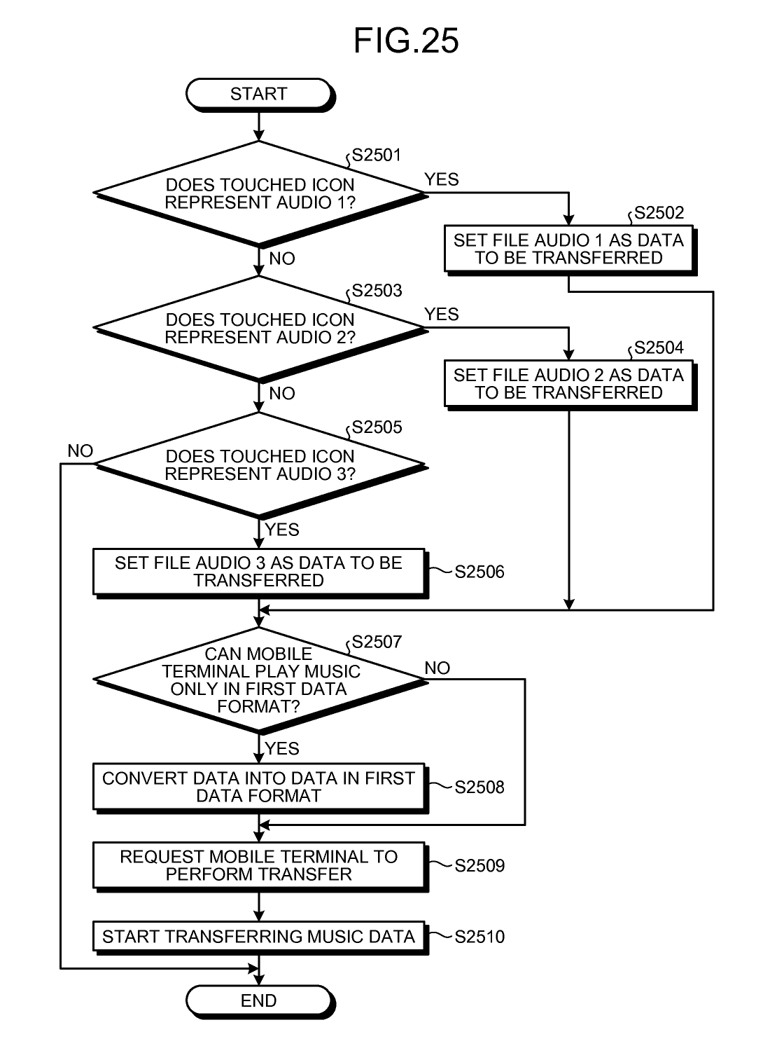

A specific process at S2303 of FIG. 23 will be described. FIG. 25 is a flowchart illustrating a procedure of the process in the display processor 1 according to the present embodiment when the touched icon is associated with music.

First, based on the position coordinates comprised in the detection signal, the determination module 103 determines whether the touched icon represents a file Audio1 (S2501). If the determination module 103 determines that the icon represents the file Audio1 (Yes at S2501), the determination module 103 sets the file Audio1 as data to be transferred (S2502). Thereafter, the process proceeds to a process at S2507.

If the determination module 103 determines that the touched icon does not represent the file Audio1 (No at S2501), the determination module 103 determines whether the touched icon represents a file Audio2 (S2503). If the determination module 103 determines that the icon represents the file Audio2 (Yes at S2503), the determination module 103 sets the file Audio2 as data to be transferred (S2504). Thereafter, the process proceeds to the process at S2507.

If the determination module 103 determines that the touched icon does not represent the file Audio2 (No at S2503), the determination module 103 determines whether the touched icon represents a file Audio3 (S2505). If the determination module 103 determines that the icon represents the file Audio3 (Yes at S2505), the determination module 103 sets the file Audio3 as data to be transferred (S2506). Thereafter, the process proceeds to the process at S2507. If the determination module 103 determines that the icon does not represent the file Audio3 (No at S2505), no particular processing with respect to music is performed.

After S2502, S2504, or S2506, the determination module 103 determines, based on the acquired attribute information, whether only a first data format (such as AAC) is playable (S2507). A plurality of data formats (such as AAC and MP3) of music data are assumed to exist.

If the determination module 103 determines that a format other than the first data format is playable (No at S2507), the process proceeds to S2509 because the music data can be sent as it is. If the determination module 103 determines that the mobile terminal can play music only in the first data format (Yes at S2507), the start-up module 104 starts a conversion program that converts a data format of music data into the first data format, and the conversion program converts the music data into data in the first data format (S2508).

After S2507 and S2508, the start-up module 104 starts a music transfer program. The music transfer program requests the mobile terminal to perform transfer (S2509). Thereafter, the music transfer program starts transferring the music data set as the data to be transferred (S2510).

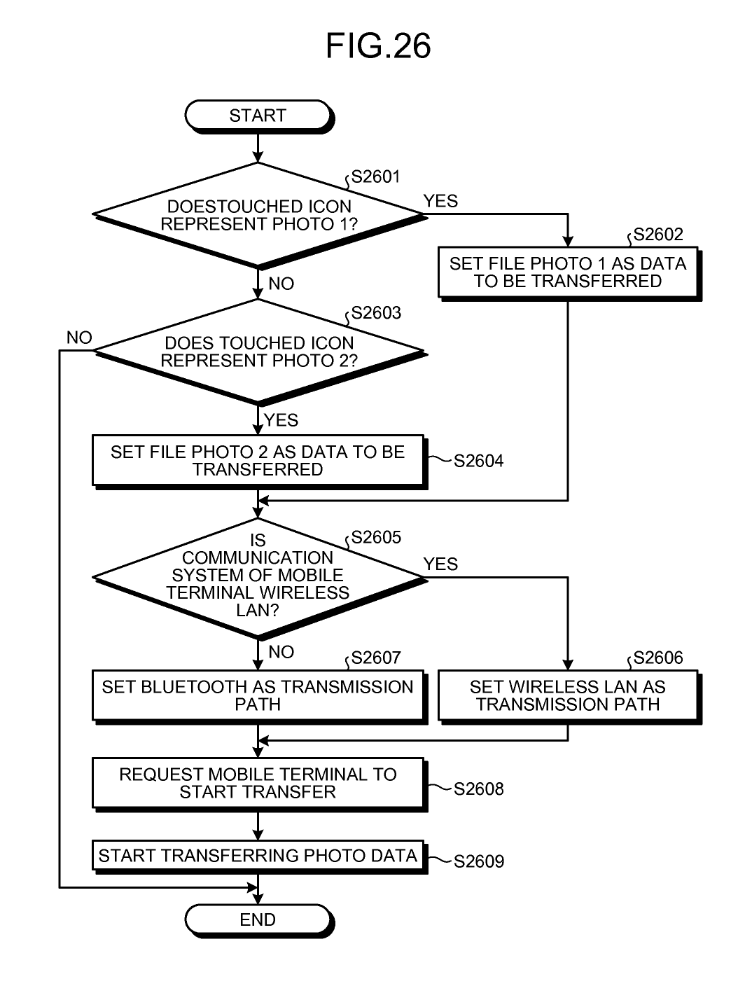

A specific process at S2304 of FIG. 23 will be described. FIG. 26 is a flowchart illustrating a procedure of the process in the display processor 1 according to the present embodiment when the touched icon is associated with a photograph.

First, based on the position coordinates included in the detection signal, the determination module 103 determines whether the touched icon represents a file Photo1 (S2601). If the determination module 103 determines that the icon represents the file Photo1 (Yes at S2601), the determination module 103 sets the file Photo1 as data to be transferred (S2602). Thereafter, the process proceeds to a process at S2605.

If the determination module 103 determines that the touched icon does not represent the file Photo1 (No at S2601), the determination module 103 determines whether the touched icon represents a file Photo2 (S2603). If the determination module 103 determines that the icon represents the file Photo2 (Yes at S2603), the determination module 103 sets the file Photo2 as data to be transferred (S2604). Thereafter, the process proceeds to the process at S2605. If the determination module 103 determines that the icon does not represent the file Photo2 (No at S2603), no particular processing with respect to a photograph is performed.

After S2602 or S2604, the determination module 103 determines, based on the acquired attribute information, whether the communication system of the mobile terminal is the wireless LAN (S2605). The present embodiment assumes the communication system to be selected from two types, that is, the wireless LAN and Bluetooth (registered trademark).

If the determination module 103 determines the mobile terminal can communicate via the wireless LAN (Yes at S2605), the wireless LAN is set as a transmission path (S2606). If the determination module 103 determines the mobile terminal cannot communicate via the wireless LAN (No at S2605), Bluetooth (registered trademark) is set as the transmission path (S2607).

The start-up module 104 starts a photo transfer program. The photo transfer program requests the mobile terminal to start transfer of the photo data (S2608). Then, the photo transfer program starts transferring the file (photo data) set as the data to be transferred (S2609).

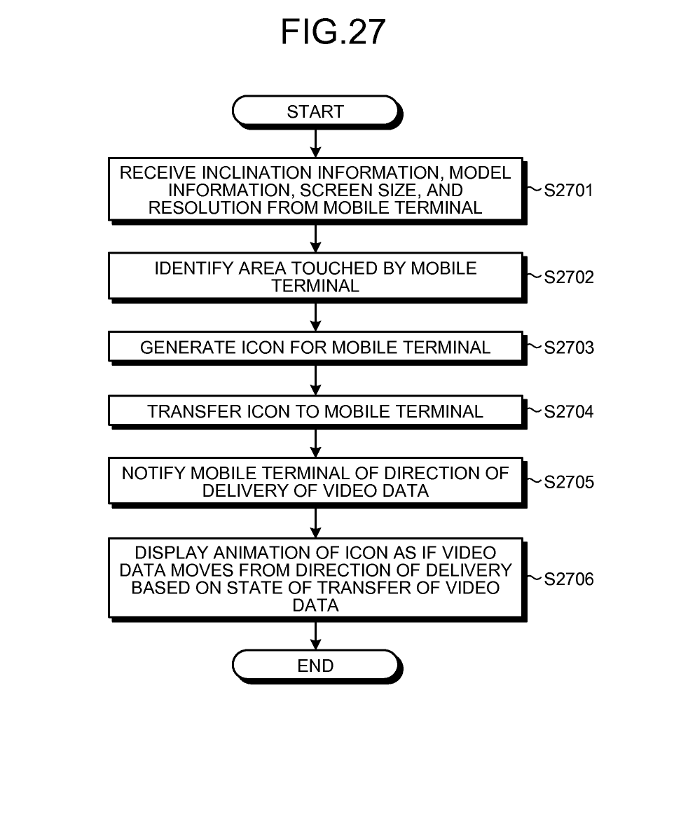

The present embodiment displays an animation of an icon while the data is transferred. A description will be made below of a process during the video transfer at S2409 of FIG. 24. FIG. 27 is a flowchart illustrating a procedure in which the display processor 1 according to the present embodiment downloads the video data to the mobile terminal 400.

First, in cooperation with the video transfer program, the communication controller 101 receives the inclination information detected in the mobile terminal 400, the model information for identifying the mobile terminal 400, the screen size, and the resolution, from the mobile terminal 400 (S2701). The display processor 1 may identify the screen size and the resolution based on the model information.

Then, based on the position coordinates where the contact is detected by the detector 102 and on the received inclination information, the video transfer program identifies an area touched by the mobile terminal 400 on the display 11 (S2702). To improve the accuracy of the identification of the area touched by the mobile terminal 400, for example, the size of the mobile terminal 400 may be acquired.

Thereafter, based on the screen size and the resolution of the mobile terminal 400, the video transfer program generates an icon representing the video data to be transferred (S2703).

Then, in cooperation with the video transfer program, the communication controller 101 transfers the generated icon (S2704). The transferred icon is used for displaying the communication status on the mobile terminal 400.

Further, in cooperation with the video transfer program, the communication controller 101 gives a notification of a direction of delivery of the video data on the display 11 (S2705). The mobile terminal 400 uses this information to display the animation of the icon as if the video data moves from the direction of delivery.

Thereafter, in cooperation with the video transfer program, the display controller 105 displays the animation of the icon as if the video data moves from the direction of delivery corresponding to the state of transfer of the video data (S2706).

With reference to FIG. 27, the description has been made of the animation display in the case of transferring the video data. Similar procedures are used for processes for the music data and the photo data, and descriptions thereof are omitted.

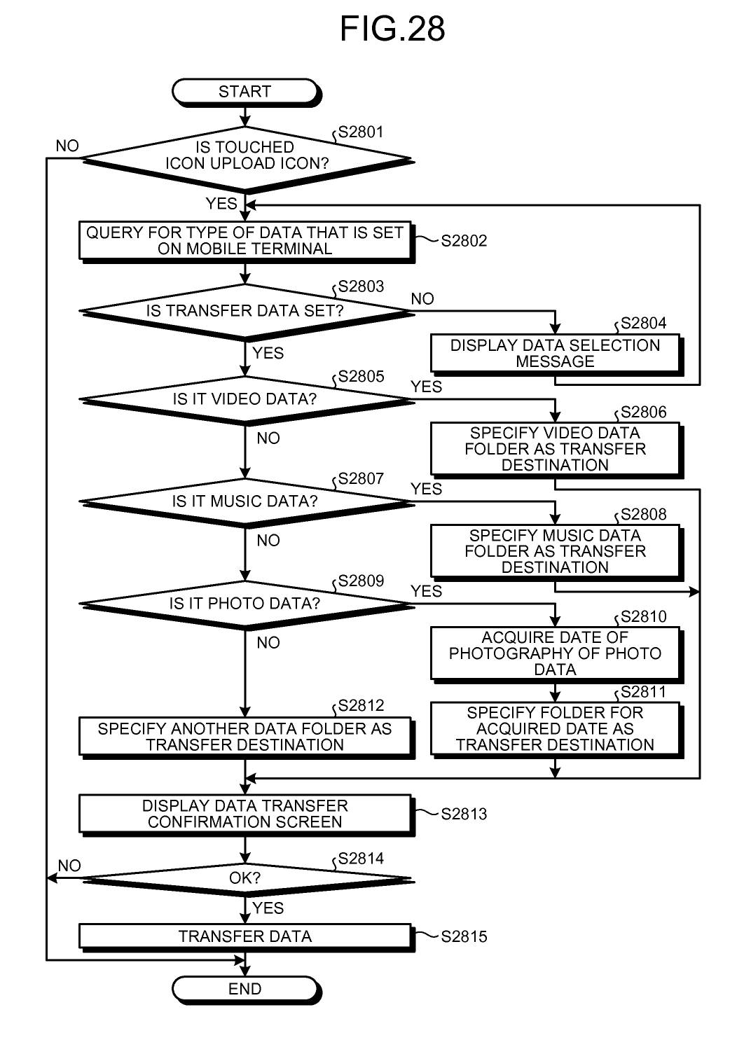

A specific process at S2305 of FIG. 23 will be described. FIG. 28 is a flowchart illustrating a procedure of the process in the display processor 1 according to the present embodiment when the touched icon is associated with the upload.

First, based on the position coordinates comprised in the detection signal, the determination module 103 determines whether the touched icon is the upload icon (S2801). If the determination module 103 determines that the icon is not the upload icon (No at S2801), the process ends.

If the determination module 103 determines that the touched icon is the upload icon (Yes at S2801), the communication controller 101 queries for the type of data that is set as data to be sent on the mobile terminal 400 (S2802).

Based on the query result received by the communication controller 101, the determination module 103 determines whether transfer data is set on the mobile terminal 400 (S2803). If the determination module 103 determines that no transfer data is set (No at S2803), the start-up module 104 starts the message display program. In cooperation with the display controller 105, the display program displays a selection message such as “Select data on a source device to transfer data and touch this icon with the device” (S2804). Thereafter, the process proceeds to the process at S2802.

If the determination module 103 determines that transfer data is set (Yes at S2803), the determination module 103 determines whether the transfer data is video data (S2805). If the determination module 103 determines that the transfer data is video data (Yes at S2805), the start-up module 104 starts the video transfer program. The video transfer program specifies a video data folder as a transfer destination (S2806), and the process proceeds to a process at S2813.

If the determination module 103 determines that the transfer data is not video data (No at S2805), the determination module 103 determines whether the transfer data is music data (S2807). If the determination module 103 determines that the transfer data is music data (Yes at S2807), the start-up module 104 starts the music transfer program. The music transfer program specifies a music data folder as the transfer destination (S2808), and the process proceeds to the process at S2813.

If the determination module 103 determines that the transfer data is not music data (No at S2807), the determination module 103 determines whether the transfer data is photo data (S2809). If the determination module 103 determines that the transfer data is photo data (Yes at S2809), the start-up module 104 starts the photo transfer program. The photo transfer program acquires the date of photography of the photo data for a photo data folder (S2810). Thereafter, the photo transfer program specifies a folder for the acquired date as the transfer destination (S2811), and the process proceeds to the process at S2813.

If the determination module 103 determines that the transfer data is not photo data (No at S2809), the start-up module 104 starts a transfer program, which in turn specifies another data folder as the transfer destination (S2812), and the process proceeds to the process at S2813.

Thereafter, the started multi-type transfer program displays a data transfer confirmation screen (S2813). Then, it is determined whether the multi-type transfer program has accepted a selection of “OK” (S2814). If the multi-type transfer program has not accepted the selection of “OK” (No at S2814), the process ends.

If the multi-type transfer program has accepted the selection of “OK” (Yes at S2814), the multi-type transfer program transfers the data from the mobile terminal 400 (S2815).

The above-described procedures allow the transfer of data. The above description of the process has been made of the case in which the transfer programs are started. However, the started programs are not limited to the transfer programs. Other programs such as a program for electronic payment may be used as the started programs.

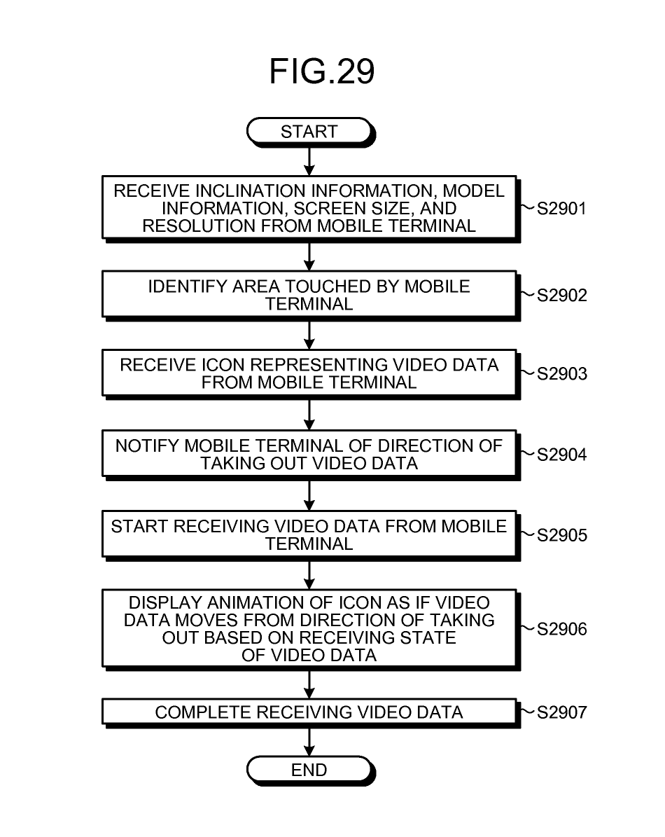

The present embodiment displays the animation of the icon while the data is transferred. A description will be made below of the process during the data transfer at S2815 of FIG. 28. FIG. 29 is a flowchart illustrating a process in the display processor 1 according to the present embodiment when the upload of the video data from the mobile terminal 400 is accepted.

First, in cooperation with the video transfer program, the communication controller 101 receives the inclination information detected in the mobile terminal 400, the model information for identifying the mobile terminal 400, the screen size, and the resolution, from the mobile terminal 400 (S2901). The display processor 1 may identify the screen size and the resolution based on the model information.

Then, based on the position coordinates where the contact is detected by the detector 102 and on the received inclination information, the video transfer program identifies the area touched by the mobile terminal 400 on the display 11 (S2902). To improve the accuracy of the identification of the area touched by the mobile terminal 400, for example, the size of the mobile terminal 400 may be acquired.

Thereafter, the communication controller 101 receives, from the mobile terminal 400, an icon representing the video data to be transferred (S2903).

Further, in cooperation with the video transfer program, the communication controller 101 gives a notification of a direction of taking out the video data on the display 11 (S2904). The mobile terminal 400 uses this information to display the animation of the icon as if the video data moves toward the direction of taking out.

The communication controller 101 starts receiving the video data from the mobile terminal 400 in cooperation with the video transfer program (S2905).

Thereafter, in cooperation with the video transfer program, the display controller 105 displays the animation of the icon as if the video data moves toward the direction of taking out corresponding to the state of transfer of the video data (S2906).

After receiving the entire video data, the communication controller 101 finishes receiving the video data from the mobile terminal 400 (S2907).

In the present embodiment, the description has been made of the examples of displaying the animation of the icon corresponding to the amount of data completed to be transferred. However, the display mode is not limited to animating the icon in a manner proportional to the amount of transfer.

The present embodiment does not limit the animation display to be started at the same time as the start of the transfer of data, but the timing only needs to be associated with the transfer operation of data. For example, the animation display may be started at the time when the transfer is finished, or may be started at the time when the icon is touched.

The present embodiment does not limit the display information representing data to an icon. The display information only needs to be image data representing data, and, for example, may be a thumbnail. Using a thumbnail makes it easy to allow the user to understand what the content of the data being transferred is.

In the present embodiment, the description has been made of the examples in which the display processor 1 has the display 11 vertically arranged like a television display device, and therefore identifies the area touched by the mobile terminal 400 by receiving the inclination information of the mobile terminal 400. However, the display 11 is not limited to the case of being vertically arranged, but may be, for example, horizontally arranged. In this case, obtaining direction information from a mobile terminal with a compass function allows the identification of the area touched by the mobile terminal.

In the above-described display processor 1 of the present embodiment, when a mobile terminal touches an icon of the display 11, the touching mobile terminal is identified from an acquired acceleration detection signal, and then a program for transmitting data to the mobile terminal is started. This allows the transfer to be performed to the mobile terminal intended by the user when a plurality of mobile terminals exist that can transmit and receive data to and from the display processor 1. This can suppress wrong transmission and thus can improve convenience of the user.

Passing appropriate attribute information of the mobile terminal to the started program allows the program to execute a program corresponding to the mobile terminal, and thus can improve convenience.

By displaying the animation corresponding to the state of transfer data, the above-described display processor 1 allows the user to understand the state of the transfer. Furthermore, varying the display mode depending on the position where the mobile terminal is placed makes it easy to allow the user to intuitively understand the currently executed process.

Moreover, transferring an icon representing data before transferring the data makes it easy to allow the user to understand what kind of data will be transferred. In addition, icons displayed on the display processor 1 and the mobile terminal 400 can be synchronized with each other. This improves visibility.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display processor comprising:
a display comprising a display area;
a detector configured to detect contact within the display area;
a communication module configured to allow transmission and reception of data with respect to a communication terminal; and
a display controller configured to display animation upon receipt of data from the communication terminal by the communication module when contact of the communication terminal within the display area is detected by the detector, or to display animation upon transmission of data to the communication terminal by the communication module when contact of the communication terminal within the display area is detected by the detector, the animation displayed upon receipt of the data from the communication terminal being configured to move display information representing the data received by the communication module so that a size of the display information is increased from a position at which the contact of the communication terminal is detected, the animation displayed upon transmission of the data to the communication terminal being configured to move display information representing the data transmitted to the communication module so that a size of the display information is decreased toward a position at which the contact of the communication terminal is detected.

2. A display processor comprising:
a communication module configured to allow transmission and reception of data with respect to a communication terminal; and
a display controller configured to display animation upon receipt of data from the communication terminal by the communication module when contact of the communication terminal with respect to within a display area of a display is detected by the detector, or to display animation upon transmission of data to the communication terminal by the communication module when contact of the communication terminal within the display area is detected by the detector, the animation displayed upon receipt of the data from the communication terminal being configured to move display information representing the data received by the communication module so that a size of the display information is increased from a position at which the contact of the communication terminal is detected, the animation displayed upon transmission of the data to the communication terminal being configured to move display information representing the data transmitted to the communication module so that a size of the display information is decreased toward a position at which the contact of the communication terminal is detected.

3. The display processor of claim 1, wherein,
upon transmission of the data to the communication terminal, the display controller is configured to display animation in which the display information representing the data is moved toward the communication terminal, and,
upon receipt of the data from the communication terminal, the display controller is configured to display animation in which the display information representing the data is coming out from the communication terminal.

4. The display processor of claim 2, wherein,
upon transmission of the data to the communication terminal, the display controller is configured to display animation in which the display information representing the data is moved toward the communication terminal, and,
upon receipt of the data from the communication terminal, the display controller is configured to display animation in which the display information representing the data is coming out from the communication terminal.

5. The display processor of claim 1, wherein the display controller is configured to vary the animation of the display information in accordance with the position at which the contact of the communication terminal has been detected.

6. The display processor of claim 2, wherein the display controller is configured to vary the animation of the display information in accordance with the position at which the contact of the communication terminal has been detected.

7. The display processor of claim 1, wherein
the communication module is configured to receive, from the communication terminal of which the contact has been detected by the detector, inclination information indicating an inclination of the communication terminal with respect to the display processor, and
the display controller is configured to display animation of the display information based on the inclination information.

8. The display processor of claim 2, wherein
the communication module is configured to receive, from the communication terminal of which the contact has been detected by the detector, inclination information indicating an inclination of the communication terminal with respect to the display processor, and
the display controller is configured to display animation of the display information based on the inclination information.

9. The display processor of claim 1, wherein the display controller is configured to vary a display mode of the display information based on a degree of progress of transmission and reception of the data between the communication terminal and the communication module.

10. The display processor of claim 2, wherein the display controller is configured to vary a display mode of the display information based on a degree of progress of transmission and reception of the data between the communication terminal and the communication module.

11. The display processor of claim 1, wherein
the communication module is configured to receive at least one of model information, a screen size, and a resolution of the communication terminal from the communication terminal of which the contact has been detected by the detector, and,
upon transmission of the data to the communication terminal by the communication module, the communication module is configured to transmit the display information representing the data generated based on the model information, the screen size, and/or the resolution of the communication terminal to the communication terminal before transmitting the data.

12. The display processor of claim 2, wherein
the communication module is configured to receive at least one of model information, a screen size, and a resolution of the communication terminal from the communication terminal of which the contact has been detected by the detector, and,
upon transmission of the data to the communication terminal by the communication module, the communication module is configured to transmit the display information representing the data generated based on the model information, the screen size, and/or the resolution of the communication terminal to the communication terminal before transmitting the data.

13. The display processor of claim 1, wherein the display information displayed by the display controller is an icon or a thumbnail representing the data.

14. The display processor of claim 2, wherein the display information displayed by the display controller is an icon or a thumbnail representing the data.

15. A display processing method comprising:
detecting contact within a display area of a display;
performing transmission and reception of data with respect to a communication terminal; and
displaying animation upon receipt of data from the communication terminal by the performing when contact of the communication terminal within the display area is detected by the detecting, or displaying animation upon transmission of data to the communication terminal by the performing when contact of the communication terminal within the display area is detected by the detecting, the animation displayed upon receipt of the data from the communication terminal being configured to move display information representing the data received by the performing so that a size of the display information is increased from a position at which the contact of the communication terminal is detected, the animation displayed upon transmission of the data to the communication terminal being configured to move display information representing the data transmitted by the performing so that a size of the display information is decreased toward a position at which the contact of the communication terminal is detected.
